(19) United States
(12) Patent Application Publication
(10) Pub. No.: US 2015/0169727 A1
(43) Pub. Date: Jun. 18, 2015

(54) INFORMATION PROCESSING APPARATUS, INFORMATION PROCESSING METHOD, AND SYSTEM

(71) Applicant: SONY CORPORATION, Tokyo (JP)

(72) Inventors: Kazunori Araki, Kanagawa (JP); Naoki Kaminaeda, Kanagawa (JP); Masanori Miyahara, Tokyo (JP); Tomohiro Takagi, Kanagawa (JP)

(21) Appl. No.: 14/411,967

(22) PCT Filed: Jul. 1, 2013
(86) PCT No.: PCT/JP2013/068073

§ 371 Date: Dec. 30, 2014

(30) Foreign Application Priority Data
Sep. 3, 2012 (JP) 2012-193228

(51) Int. Cl. G06F 17/30

(52) U.S. Cl. CPC G06F 17/30598; G06F 17/3053

(57) ABSTRACT

There is provided an information processing apparatus including an item clustering unit which groups scored items which are items given scores for recommendation to users, into a plurality of scored item clusters, an extraction unit which extracts a predetermined number of items from each of the scored item clusters, and an item recommendation unit which outputs item recommendation information which is used to recommend the extracted items to the users.

### TECHNICAL FIELD

The present disclosure relates to information processing apparatuses, information processing methods, and systems.

### BACKGROUND ART

Techniques of analyzing the history of user behavior, such as, for example, purchase, viewing, eating, etc., in order to recommend items to users, have been extensively studied. Among typical examples of such analysis techniques is filtering based on feature vectors of items used in user behavior.

For example, Patent Literature 1 describes a technique (content-based filtering) of calculating feature vectors from metadata which is associated with items, etc., generating a user profile vector from the feature vectors of items which are used by a user, and recommending, to the user, a new item which has a feature vector similar to the user profile vector.

Also, for example, Patent Literature 2 describes a technique (collaborative filtering) of calculating feature vectors of items or users from the behavior history of a plurality of users which have used items, and recommending, to users, a new item based on similarity between the feature vectors.

### CITATION LIST

### Patent Literature

Patent Literature 1: JP 2002-215665A

Patent Literature 2: JP 2002-334256A

### SUMMARY OF INVENTION

### Technical Problem

In the above example item recommending techniques, a score is calculated for each item based on, for example, similarity between feature vectors, etc., and recommended items are determined based on the scores. Items are recommended in decreasing order of score, for example.

However, in most cases, the score only indicates an aspect of a user's preference to an item. Therefore, for example, when items are recommended in decreasing order to score, all the recommended items are likely to be similar to each other and less new to a user, although the user's preference is reflected in the recommended items.

Therefore, the present disclosure proposes a novel and improved information processing apparatus, information processing method, and system which can recommend items reflecting a wider variety of user preferences using the scores of items.

According to an embodiment of the present disclosure, there is provided an information processing apparatus including an item clustering unit which groups scored items which are items given scores for recommendation to users, into a plurality of scored item clusters, an extraction unit which extracts a predetermined number of items from each of the scored item clusters, and an item recommendation unit which outputs item recommendation information which is used to recommend the extracted items to the users.

According to an embodiment of the present disclosure, there is provided an information processing method including grouping scored items which are items given scores for recommendation to users, into a plurality of scored item clusters, extracting a predetermined number of items from each of the scored item clusters, and outputting item recommendation information which is used to recommend the extracted items to the users.

According to an embodiment of the present disclosure, there is provided a system including a terminal device, and one or more server apparatuses which provide a service to the terminal device. The terminal device and the one or more server apparatuses provide, in cooperation with each other, the functions of grouping scored items which are items given scores for recommendation to users, into a plurality of scored item clusters, extracting a predetermined number of items from each of the scored item clusters, and outputting item recommendation information which is used to recommend the extracted items to the users.

### Solution to Problem

Items given a score for recommendation are grouped into clusters, and items are recommended for each cluster. Therefore, items are recommended from every cluster. Therefore, for example, a bias which is likely to occur in the result of recommendation when items having higher scores are simply recommended can be prevented.

### Advantageous Effects of Invention

As described above, according to the present disclosure, item recommendation reflecting a wider variety of user preferences can be achieved using the scores of items.

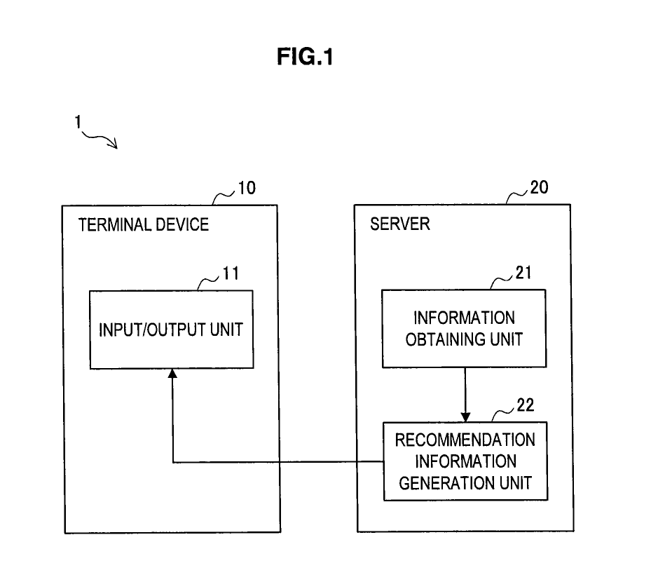

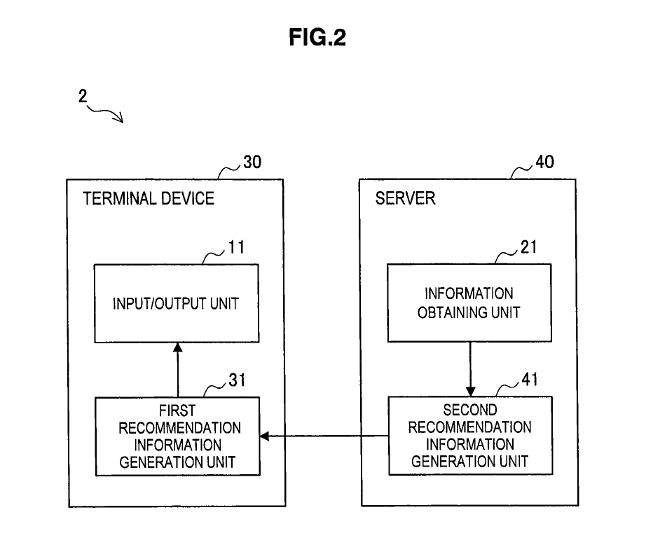

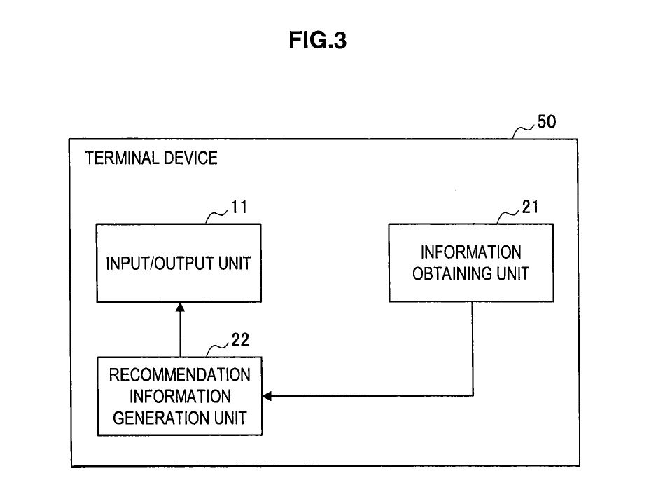

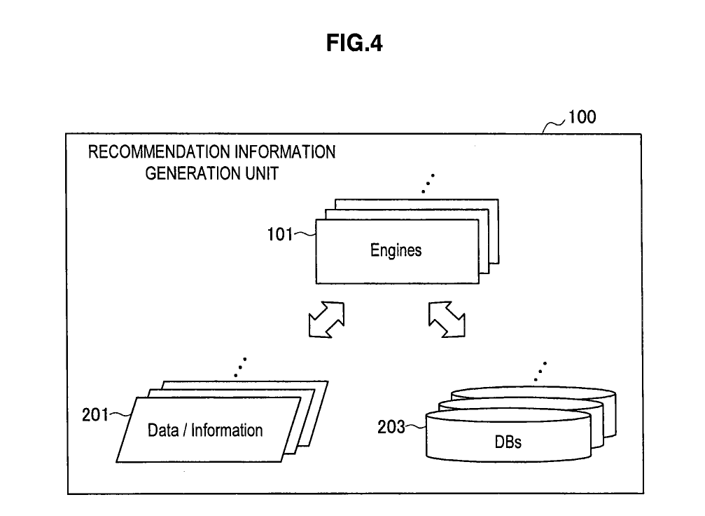

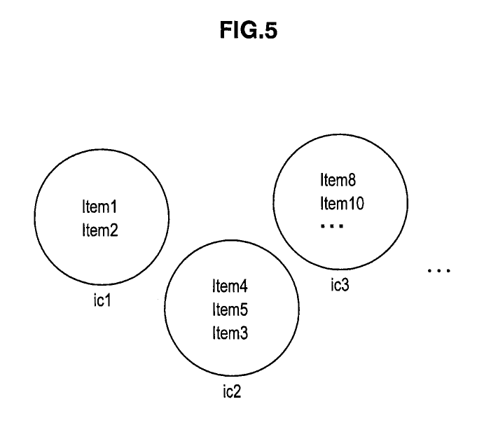

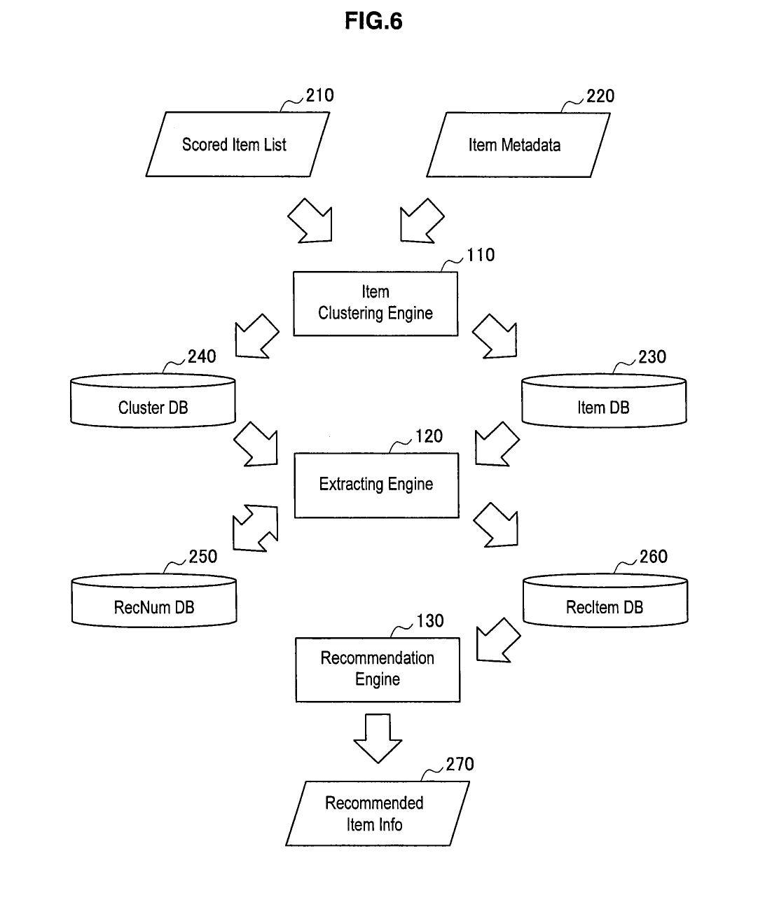

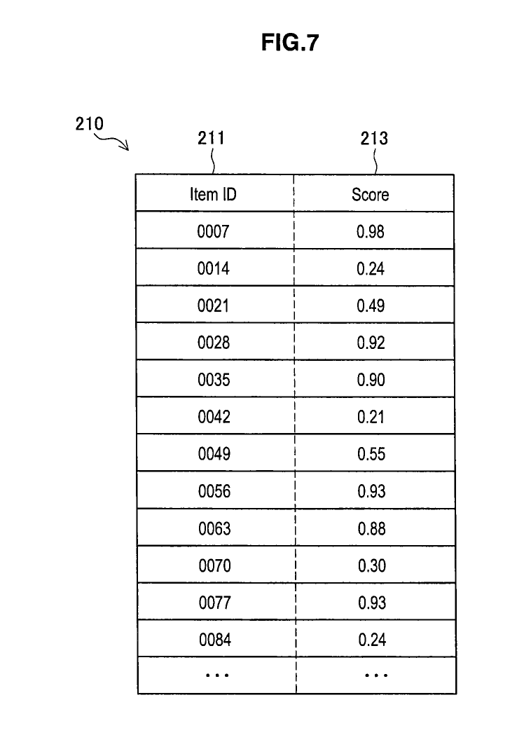

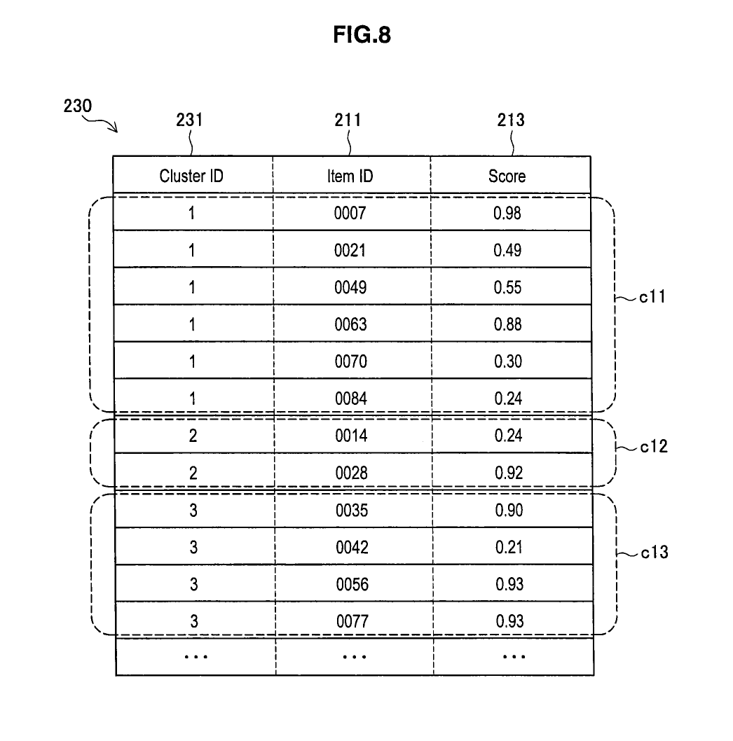

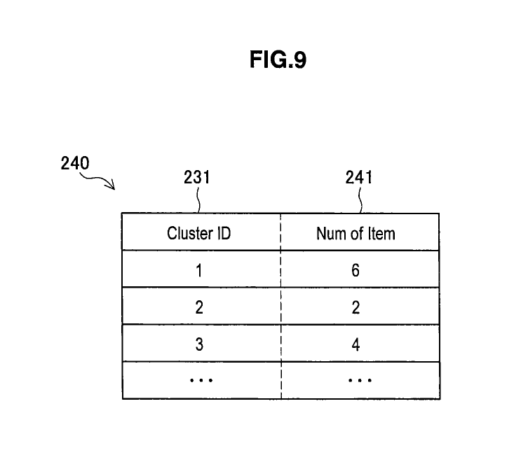

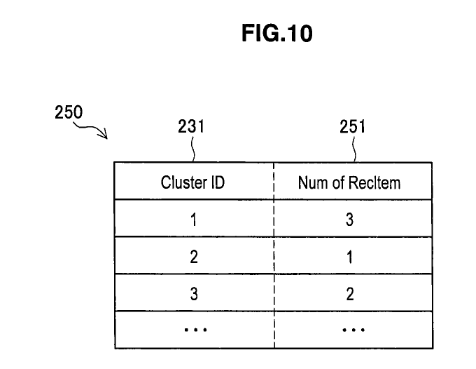

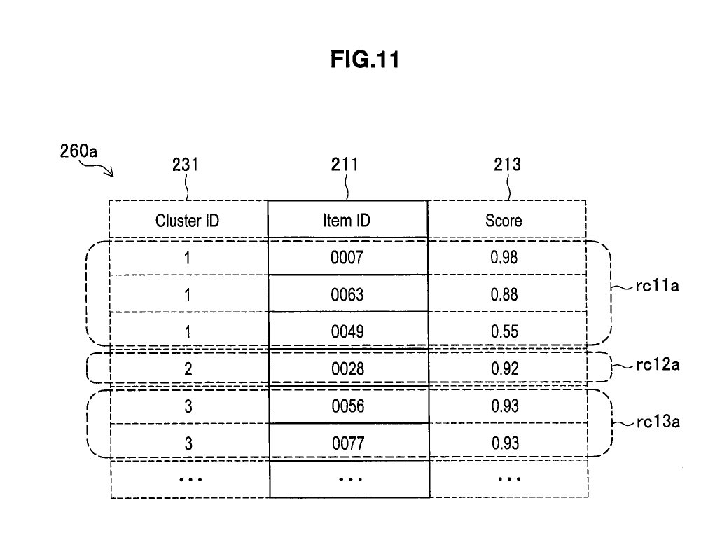

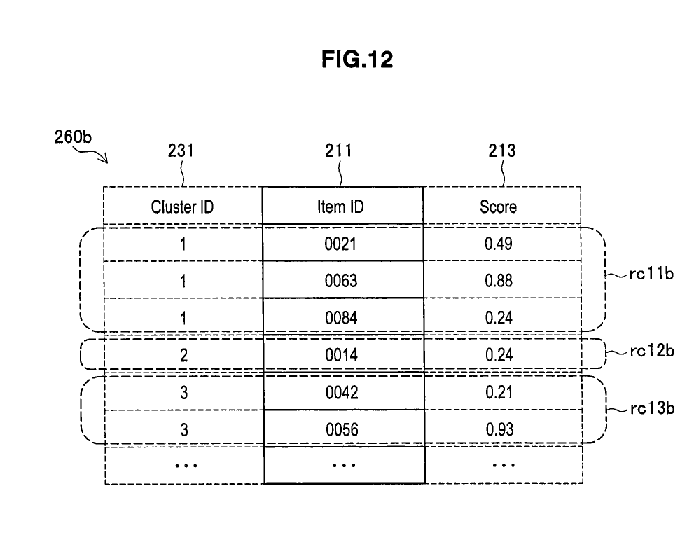

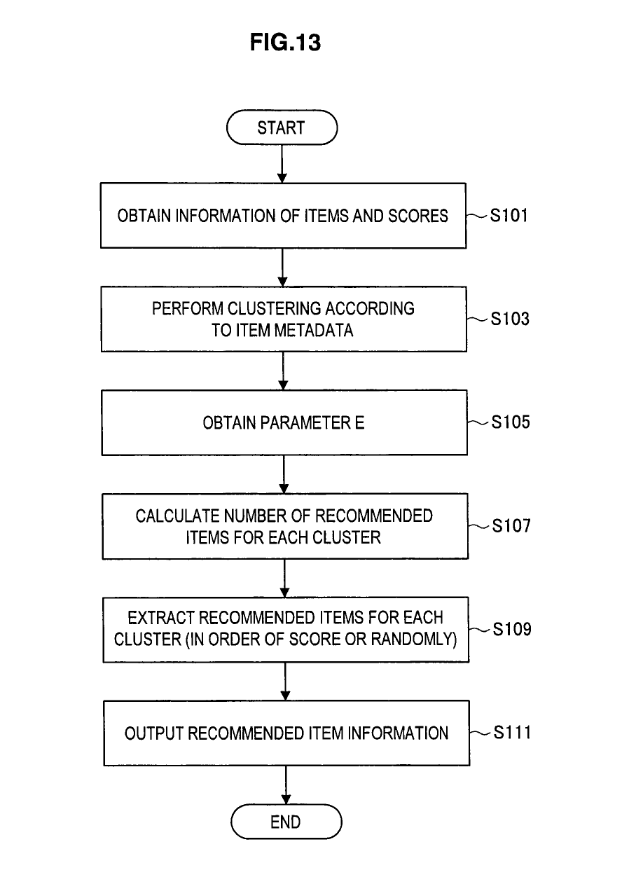

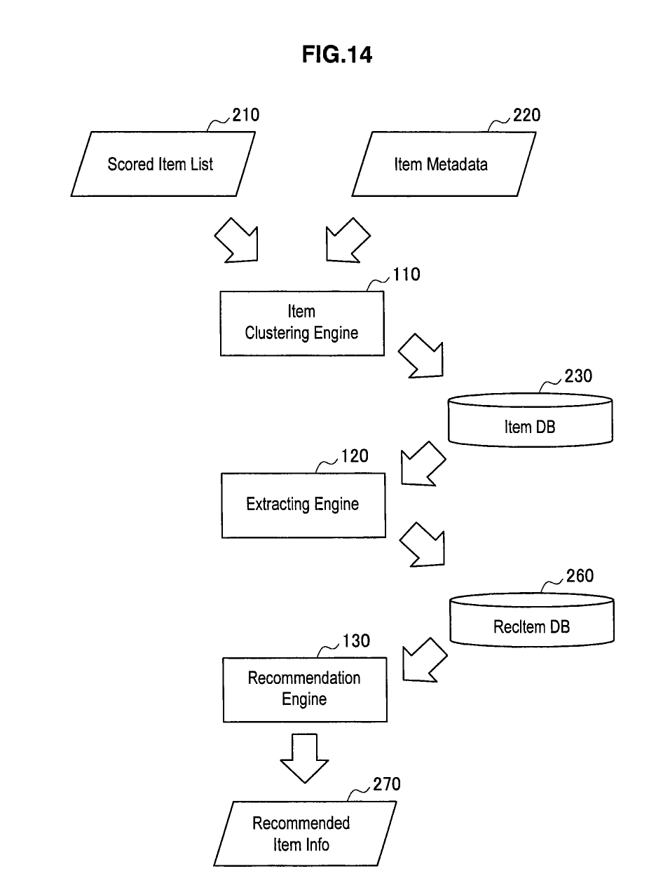

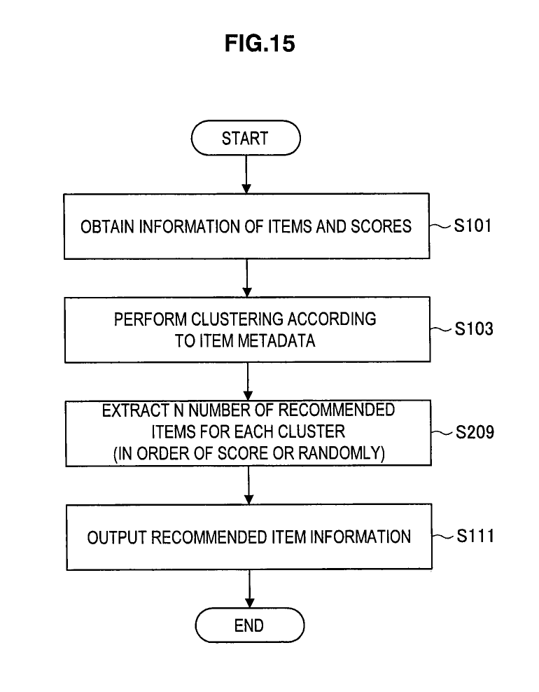

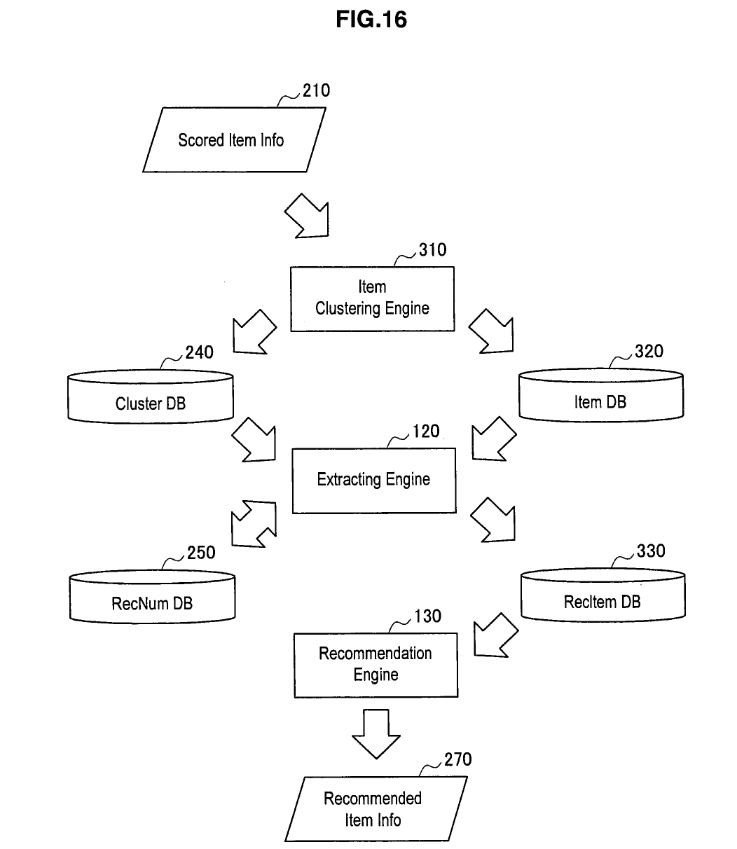

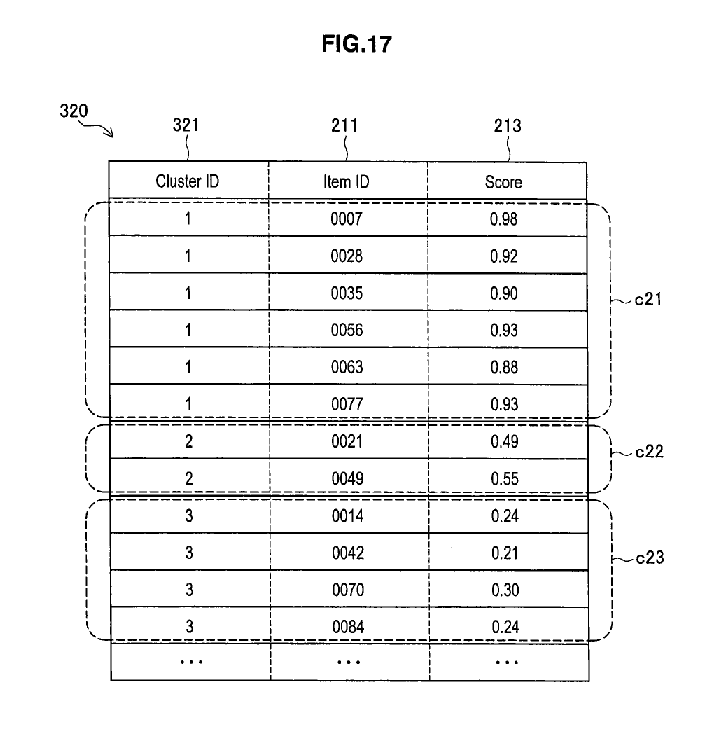

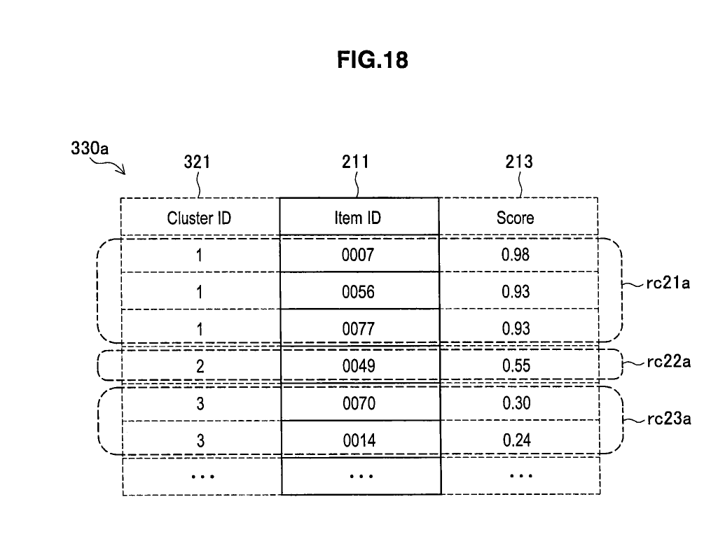

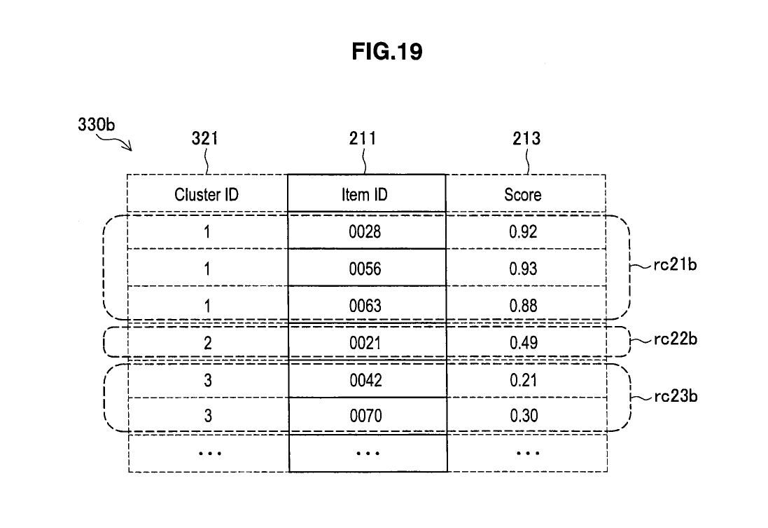

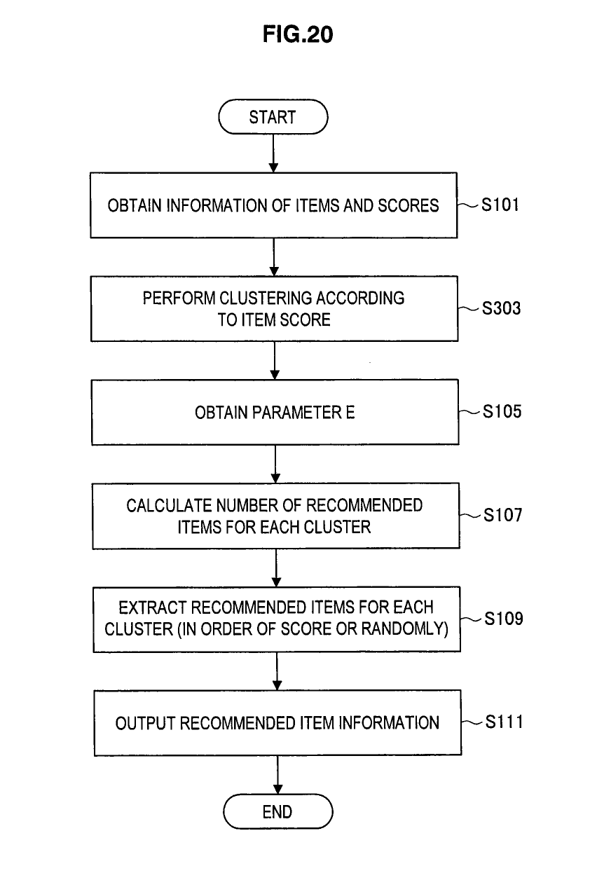

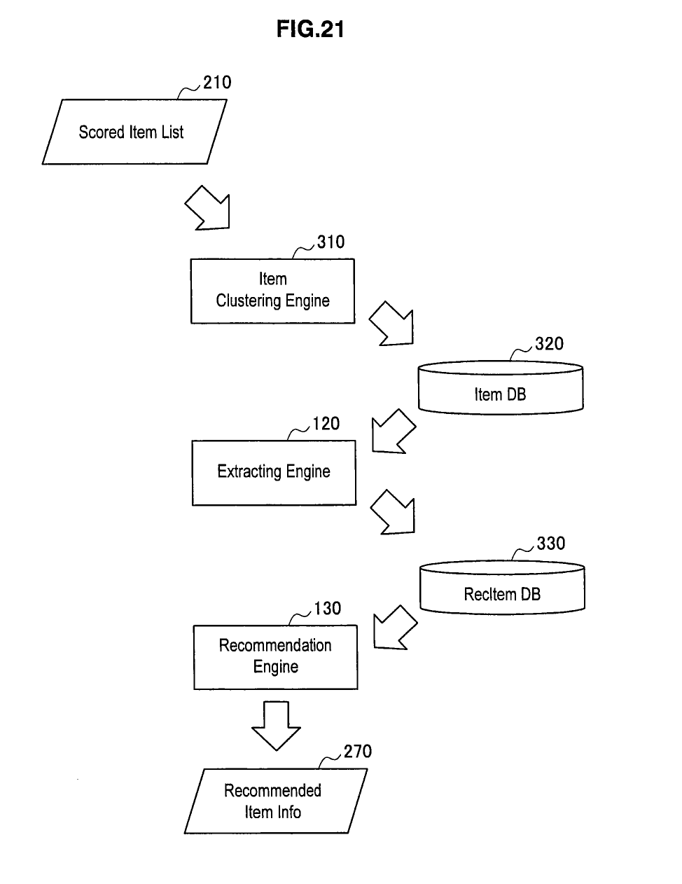

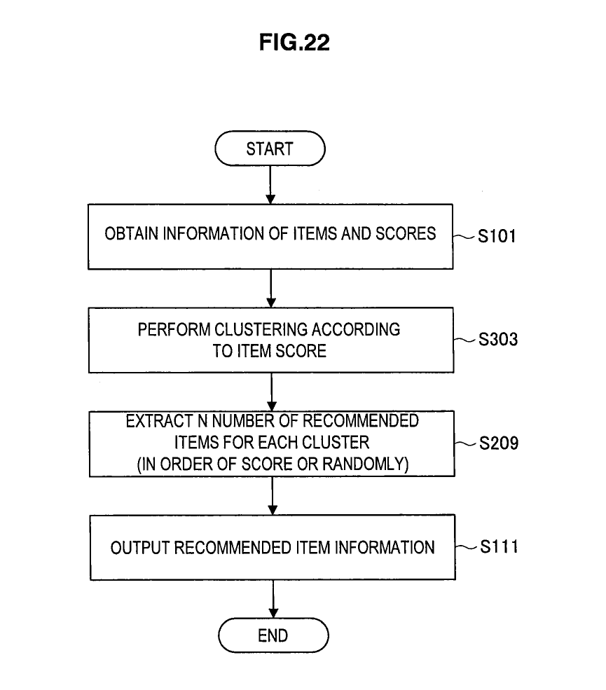

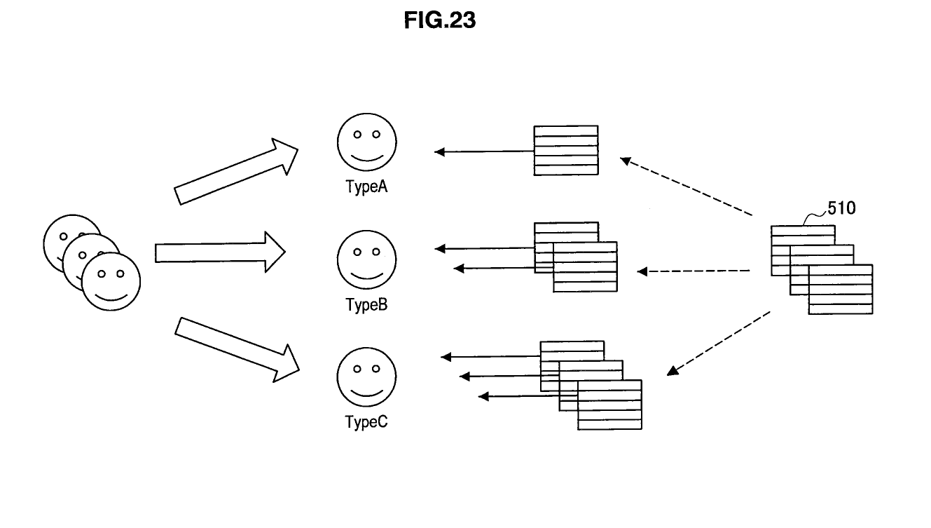

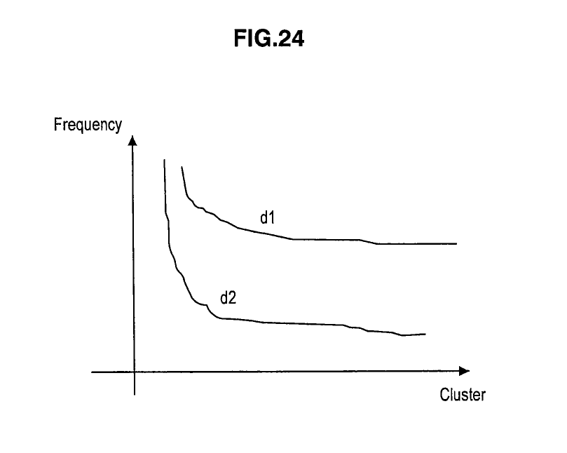

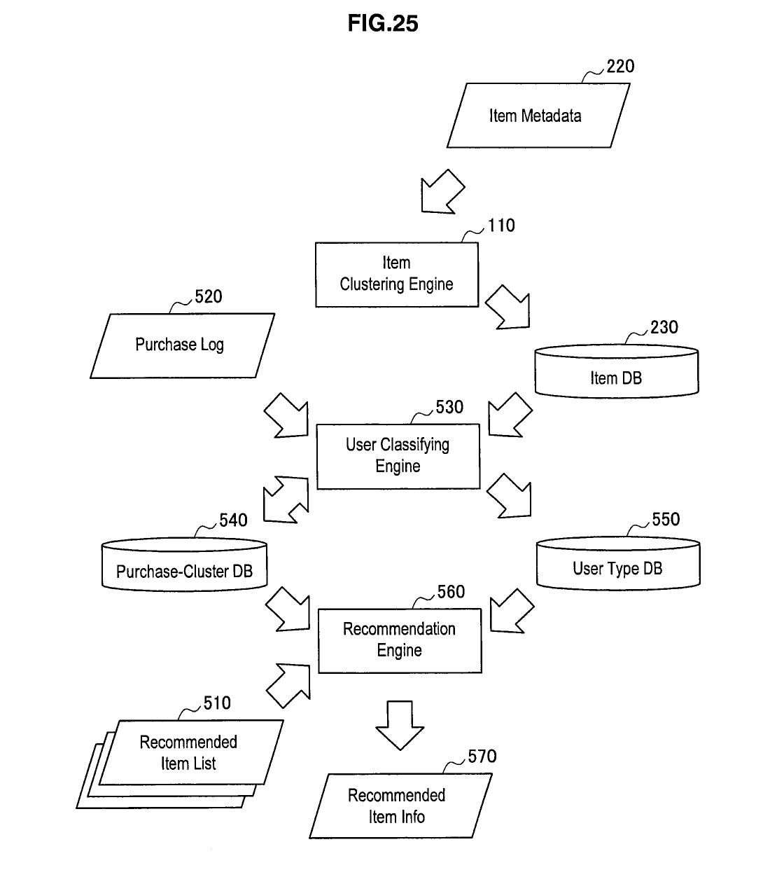

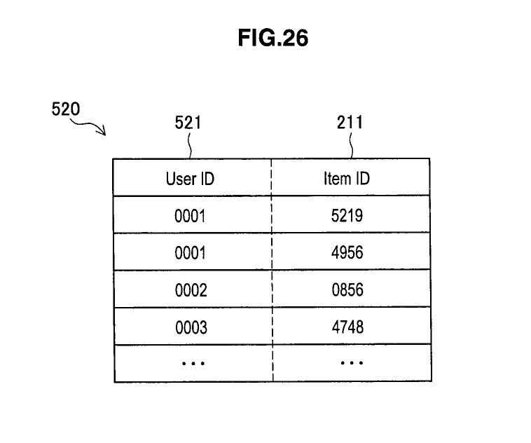

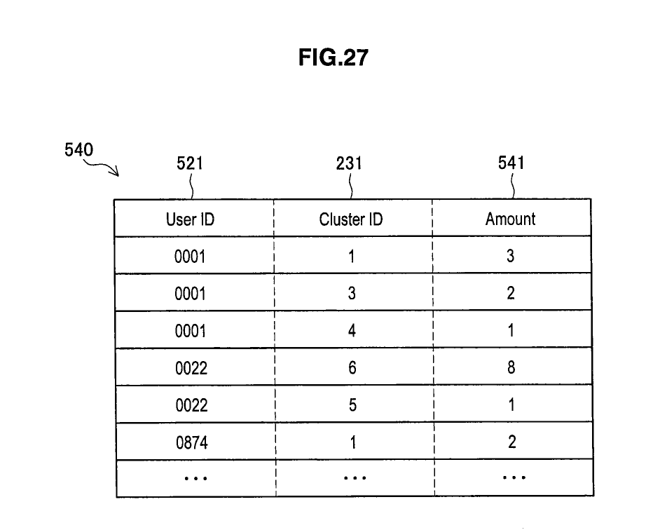

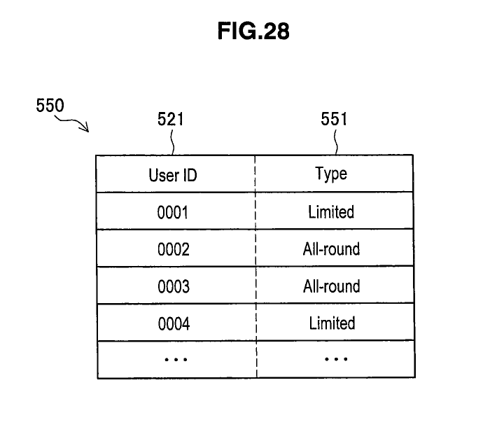

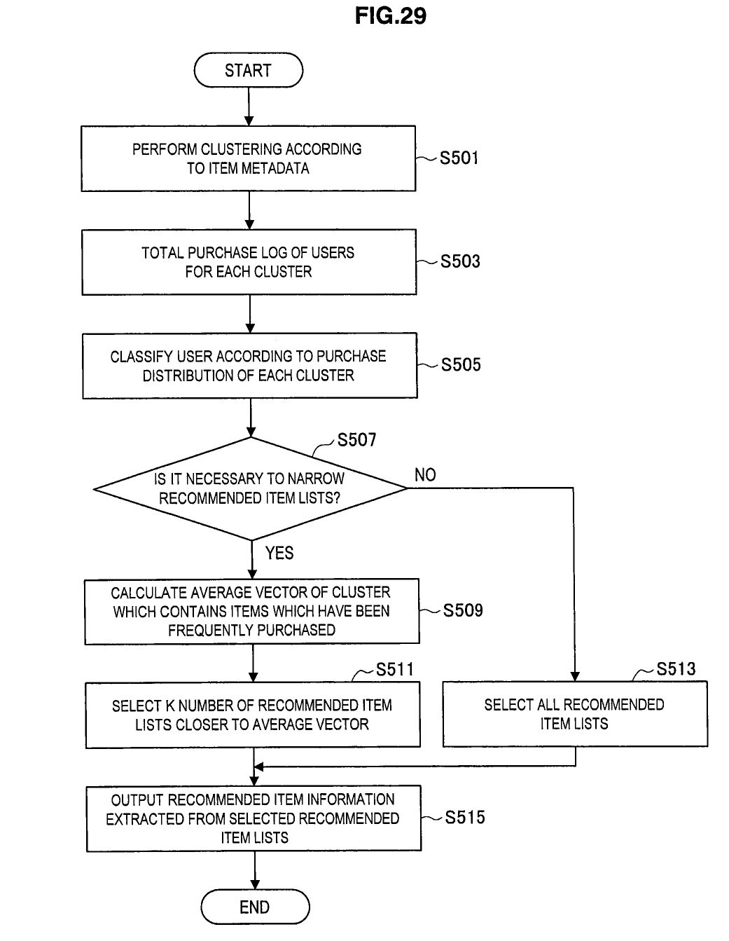

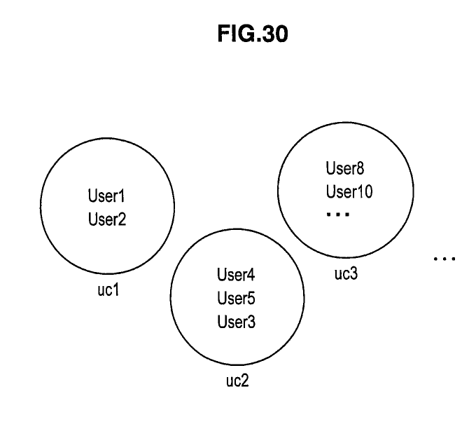

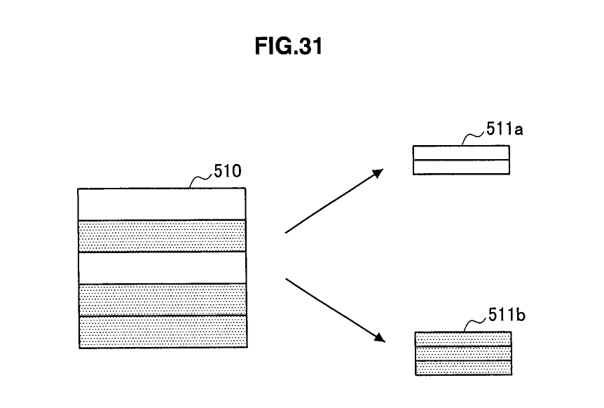

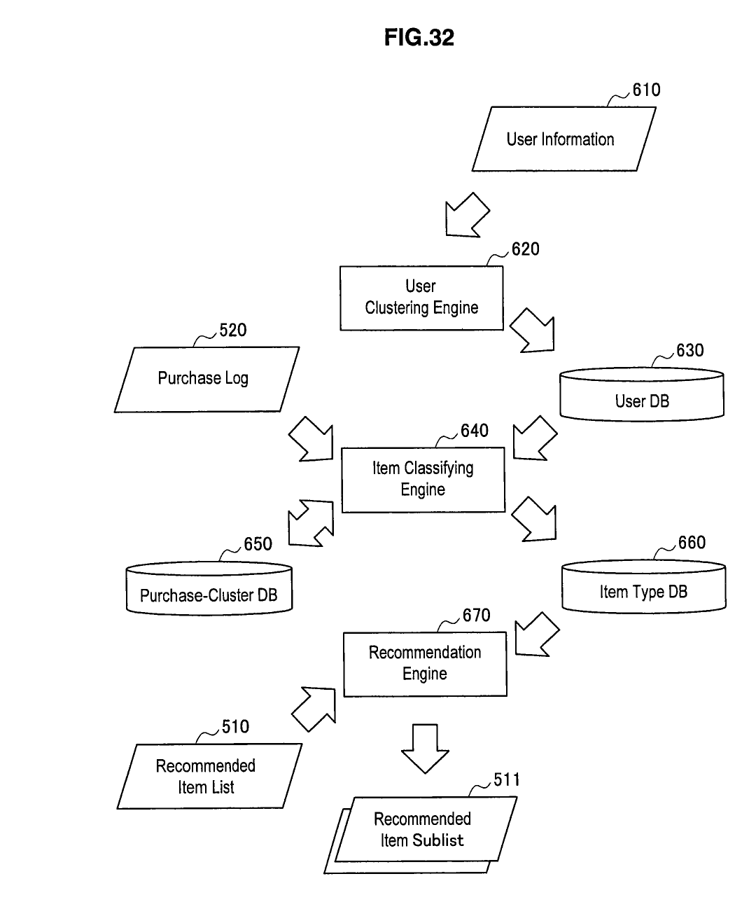

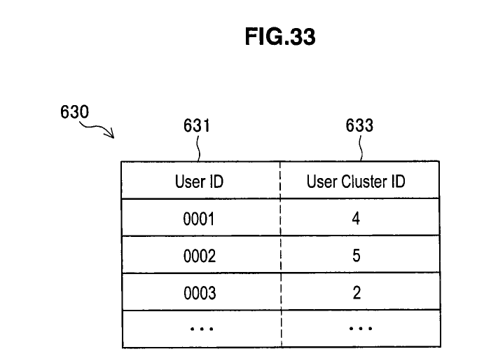

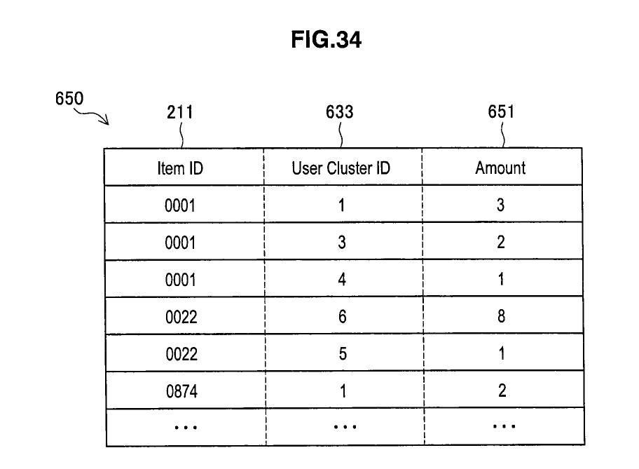

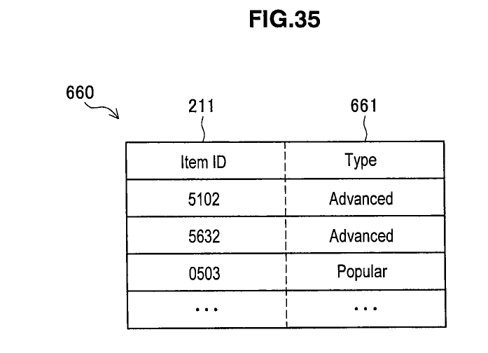

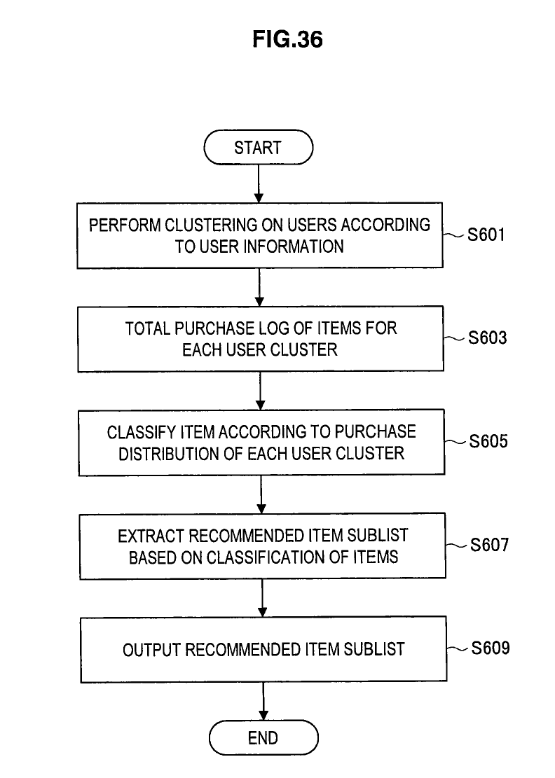

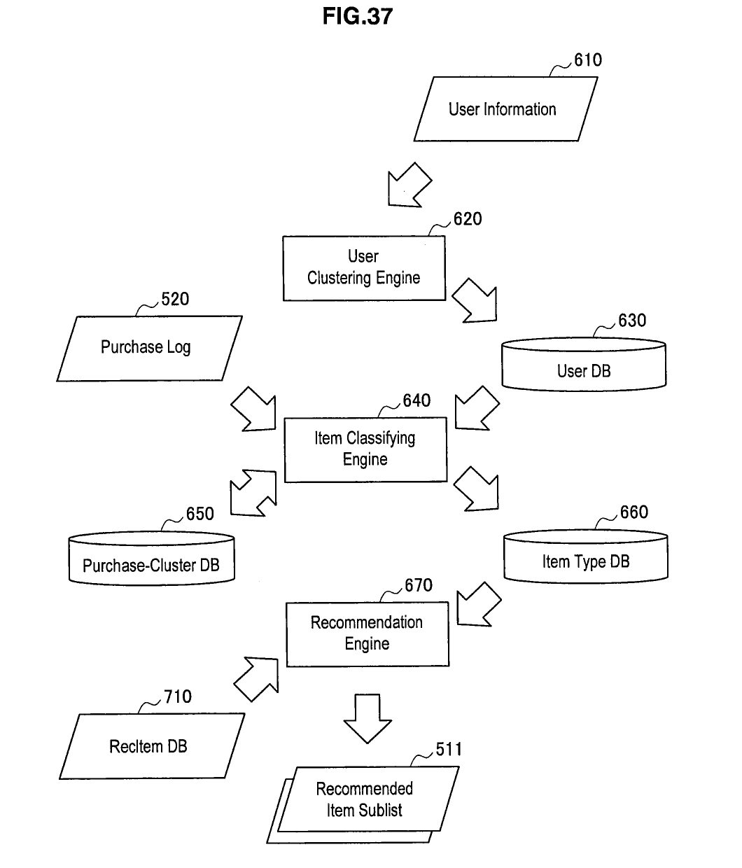

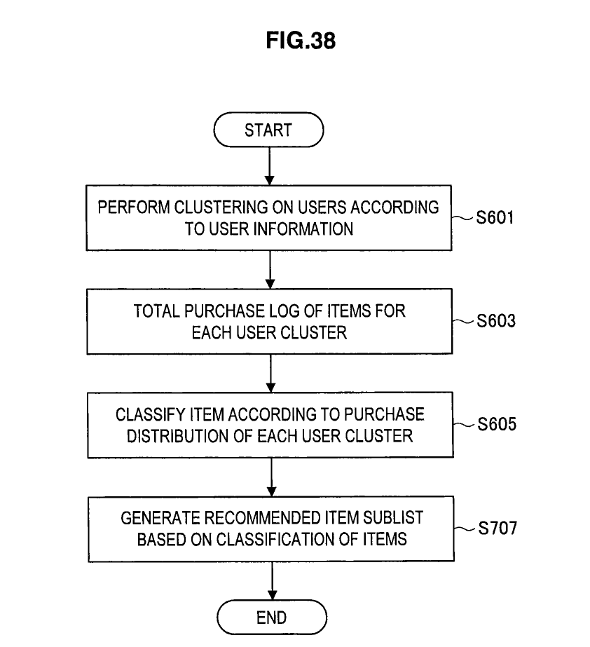

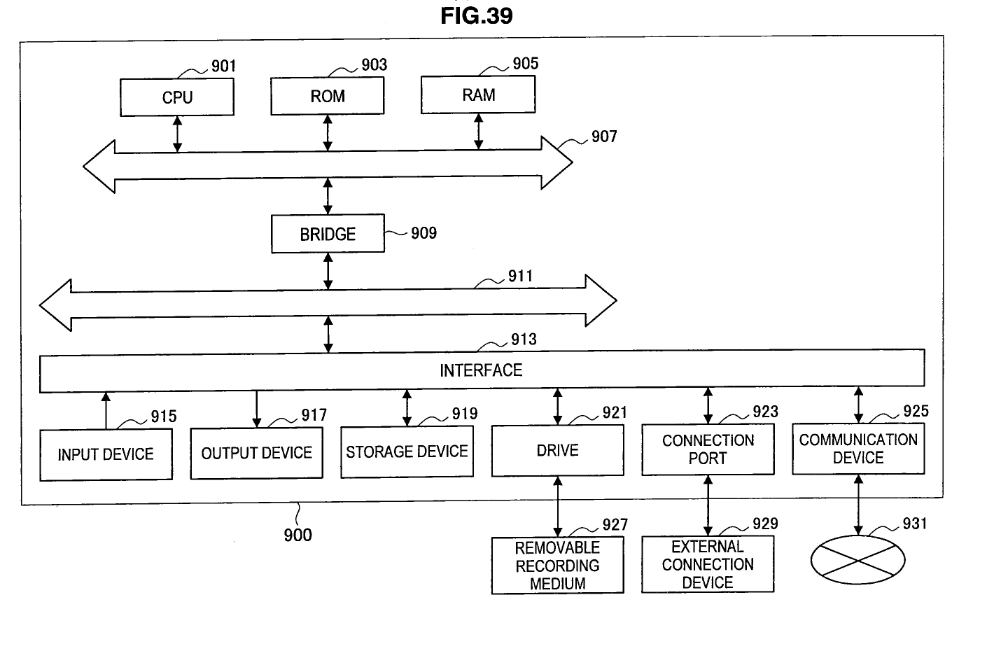

### BRIEF DESCRIPTION OF DRAWINGS

[FIG. 1] FIG. 1 is a diagram showing a first example system configuration according to an embodiment of the present disclosure.

[FIG. 2] FIG. 2 is a diagram showing a second example system configuration according to an embodiment of the present disclosure.

[FIG. 3] FIG. 3 is a diagram showing a third example system configuration according to an embodiment of the present disclosure.

[FIG. 4] FIG. 4 is a diagram showing an example configuration of a recommendation information generation unit according to an embodiment of the present disclosure.

[FIG. 5] FIG. 5 is a diagram showing the concept of clustering of items in an embodiment of the present disclosure.

[FIG. 6] FIG. 6 is a diagram schematically showing a process in a first embodiment of the present disclosure.

[FIG. 7] FIG. 7 shows an example scored item list in the first embodiment of the present disclosure.

[FIG. 8] FIG. 8 shows an example item DB in the first embodiment of the present disclosure.

[FIG. 9] FIG. 9 shows an example cluster DB in the first embodiment of the present disclosure.

[FIG. 10] FIG. 10 shows an example number-of-recommended-items DB in the first embodiment of the present disclosure.

[FIG. 11] FIG. 11 shows an example recommended item DB containing recommended items extracted using a first technique in the first embodiment of the present disclosure.

[FIG. 12] FIG. 12 shows an example recommended item DB containing recommended items extracted using a second technique in the first embodiment of the present disclosure.

[FIG. 13] FIG. 13 is a flowchart showing an example process in the first embodiment of the present disclosure.

[FIG. 14] FIG. 14 is a diagram schematically showing a process in a second embodiment of the present disclosure.

[FIG. 15] FIG. 15 is a flowchart showing an example process in the second embodiment of the present disclosure.

[FIG. 16] FIG. 16 is a diagram schematically showing a process in a third embodiment of the present disclosure.

[FIG. 17] FIG. 17 shows an example item DB in the third embodiment of the present disclosure.

[FIG. 18] FIG. 18 shows an example recommended item DB containing recommended items extracted using a first technique in the third embodiment of the present disclosure.

[FIG. 19] FIG. 19 shows an example recommended item DB containing recommended items extracted using a second technique in the third embodiment of the present disclosure.

[FIG. 20] FIG. 20 is a flowchart showing an example process in the third embodiment of the present disclosure.

[FIG. 21] FIG. 21 is a diagram schematically showing a process in a fourth embodiment of the present disclosure.

[FIG. 22] FIG. 22 is a flowchart showing an example process in the fourth embodiment of the present disclosure.

[FIG. 23] FIG. 23 is a diagram showing the concept of the control of the number of recommendation lists in an embodiment of the present disclosure.

[FIG. 24] FIG. 24 is a diagram showing example user type determination based on the number of items which have been used for each cluster.

[FIG. 25] FIG. 25 is a diagram schematically showing a process in a fifth embodiment of the present disclosure.

[FIG. 26] FIG. 26 shows an example purchase log in the fifth embodiment of the present disclosure.

[FIG. 27] FIG. 27 shows an example purchase-cluster DB in the fifth embodiment of the present disclosure.

[FIG. 28] FIG. 28 shows an example user type DB in the fifth embodiment of the present disclosure.

[FIG. 29] FIG. 29 is a flowchart showing an example process in the fifth embodiment of the present disclosure.

[FIG. 30] FIG. 30 is a diagram showing the concept of clustering of users in an embodiment of the present disclosure.

[FIG. 31] FIG. 31 is a diagram showing the concept of extraction of a recommended item sublist in a sixth embodiment of the present disclosure.

[FIG. 32] FIG. 32 is a diagram schematically showing a process in the sixth embodiment of the present disclosure.

[FIG. 33] FIG. 33 shows an example user DB in the sixth embodiment of the present disclosure.

[FIG. 34] FIG. 34 shows an example purchase-cluster DB in the sixth embodiment of the present disclosure.

[FIG. 35] FIG. 35 shows an example item type DB in the sixth embodiment of the present disclosure.

[FIG. 36] FIG. 36 is a flowchart showing an example process in the sixth embodiment of the present disclosure.

[FIG. 37] FIG. 37 is a diagram schematically showing a process in a seventh embodiment of the present disclosure.

[FIG. 38] FIG. 38 is a flowchart showing an example process in the seventh embodiment of the present disclosure.

[FIG. 39] FIG. 39 is a block diagram for explaining a hardware configuration of an information processing apparatus.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

1. System Configuration

2. Configuration of Recommendation Information Generation Unit

3. Clustering of Scored Items
3-1. First Embodiment
3-2. Second Embodiment
3-3. Third Embodiment
3-4. Fourth Embodiment

4. Control of Number of Recommendation Lists
4-1. Fifth Embodiment

5. Grouping of Items Using User Clustering
5-1. Sixth Embodiment
5-2. Seventh Embodiment

6. Hardware Configuration

7. Supplements

### 1. System Configuration

Firstly, example system configurations according to an embodiment of the present disclosure will be described with reference to FIGS. 1-3. FIGS. 1-3 show first to third example system configurations, respectively. Note that these examples are only a portion of example system configurations. As can be seen from these examples, the system configuration according to an embodiment of the present disclosure may be various other configurations in addition to those described herein.

Note that, in an embodiment of the present disclosure, an apparatus described as a terminal device may be various apparatuses which have a function of outputting information to the user and a function of receiving the user's operation, such as, for example, various PCs (Personal Computers), mobile telephones (including a smartphone), etc. Such a terminal device may, for example, be implemented using a hardware configuration of an information processing apparatus described below. The terminal device may optionally include a functional configuration which is needed to implement a function of the terminal device, such as, for example, a communication unit for communicating with a server apparatus through a network, etc., in addition to those shown in the drawings.

Also, in an embodiment of the present disclosure, a server is connected to the terminal device through various wired or wireless networks, and may be implemented by one or more server apparatuses. Individual server apparatuses may, for example, be implemented using a hardware configuration of an information processing apparatus described below. When a server is implemented by a plurality of server apparatuses, the server apparatuses are connected together through various wired or wireless networks. Each server apparatus may optionally include a functional configuration which is needed to implement a function of the server apparatus, such as, for example, a communication unit for communicating with a terminal device or another server apparatus, etc., through a network, etc., in addition to those shown in the drawings.

### First Example

FIG. 1 is a diagram showing a first example system configuration according to an embodiment of the present disclosure. In this example, a system 1 includes a terminal device 10 and a server 20.

The terminal device 10 has an input/output unit 11. The input/output unit 11, which is implemented by an output apparatus such as a display or loudspeaker, and an input apparatus such as a mouse, keyboard, or touchscreen, outputs information to the user, and receives the user's operation. Information output by the input/output unit 11 may include, for example, item recommendation information received from the server 20. On the other hand, operations obtained by the input/output unit 11 may include, for example, an operation which is performed by the user to request for item recommendation, an operation which is performed by the user to use an item by purchase, etc., and the like. In addition to this, the terminal device 10 may be implemented by a processor such as a CPU (Central Processing Unit), etc., and may include components such as a control unit which controls operations of the entire terminal device 10 including the input/output unit 11.

The server 20 has an information obtaining unit 21 and a recommendation information generation unit 22. These are, for example, implemented by a processor such as a CPU, etc., and a memory or storage device, of a server apparatus. The information obtaining unit 21 obtains, through a network, various types of information which are needed to generate recommendation information. Also, the information obtaining unit 21 may internally obtain information possessed by the server 20 itself. The information obtained by the information obtaining unit 21 may include information such as, for example, data related to items, data related to users, the history of use of items by each user, etc. The recommendation information generation unit 22 generates item recommendation information for a user based on the information obtained by the information obtaining unit 21, and outputs that information toward the terminal device 10.

In the system 1, the item recommendation information generated by the server 20 is sent to the terminal device 10. The terminal device 10 receives and outputs the item recommendation information toward the user. The terminal device 10 may additionally send a reaction of the user to the item recommendation information, such as, for example, whether or not the user has purchased a recommended item, etc., as feedback to the server 20. In this case, the recommendation information generation unit 22 of the server 20 may additionally use the received feedback to generate the recommendation information.

### Second Example

FIG. 2 is a diagram showing a second example system configuration according to an embodiment of the present disclosure. In this example, the system 2 includes a terminal device 30 and a server 40.

The terminal device 30 has a first recommendation information generation unit 31 in addition to the above input/output unit 11. The first recommendation information generation unit 31 is implemented by a processor such as a CPU, etc., and a memory or storage device, of the terminal device 30. Also, the server 40 has the above information obtaining unit 21 and a second recommendation information generation unit 41. The second recommendation information generation unit 41 is, for example, implemented by a processor such as a CPU, etc., and a memory or storage device, of a server apparatus. The first recommendation information generation unit 31 and the second recommendation information generation unit 41 cooperate with each other to implement a function similar to that of the above recommendation information generation unit 22. In other words, in the second example, the function of the recommendation information generation unit is implemented by the cooperation of the terminal device 30 and the server 40.

Note that, in this case, as described below, whether an engine, data, and DB (database) included in the recommendation information generation unit are each included in the first recommendation information generation unit 31 or the second recommendation information generation unit 41, may be arbitrarily set.

### Third Example

FIG. 3 is a diagram showing a third example system configuration according to an embodiment of the present disclosure. In this example, the system is established by a terminal device 50.

The terminal device 50 has an input/output unit 11, an information obtaining unit 21, and a recommendation information generation unit 22. Note that, each component has a function similar to that of a component having the same reference character of the above first example, and therefore, will not be described in detail.

As can be seen from the first to third examples, in the system configuration according to an embodiment of the present disclosure, although the input/output unit which outputs information to the user and receives the user's operation is implemented by the terminal device, whether the other components are implemented by the terminal device or one or more of server apparatuses, may be arbitrarily designed.

Note that even when each component according to an embodiment of the present disclosure is included in the terminal device 50 as in the above third example, a DB which is referenced in a process of the recommendation information generation unit 22 may be stored in a storage device on a server, or the history of use of items by another user may be obtained, for example. In other words, even when each component is implemented by the terminal device, not all processes are always executed in the single terminal device.

### 2. Configuration of Recommendation Information Generation Unit

FIG. 4 is a diagram showing an example configuration of a recommendation information generation unit according to an embodiment of the present disclosure. In this example, the recommendation information generation unit 100 includes an engine 101, data/information 201, and a DB 203. These components may each be plural. As described above, in an embodiment of the present disclosure, the recommendation information generation unit is implemented by a processor such as a CPU, etc., and a memory or storage device, in a terminal device or server.

The engine 101 is a program module which carries out a certain function by being read from a memory or storage device to a processor and executed. As described below, in an embodiment of the present disclosure, for example, an item clustering engine, extracting engine, recommendation engine, etc., may be provided as the engine 101 of the recommendation information generation unit 100. A plurality of the engines 101 may all be concentrated and provided in a server or terminal device, or alternatively, may be distributed and provided in a server and terminal device, for example.

The data/information 201 is various types of data or information which are input to the engine 101 or output from the engine 101. The data/information 201 is, for example, stored in a memory or storage device temporarily or permanently. The data/information 201 may include various types of information which are needed to generate recommendation information, such as, for example, data related to items, data related to users, the history of use of items by each user, etc. Such information may, for example, be obtained by the above information obtaining unit 21 through a network or internally. Also, the data/information 201 may include generated recommendation information, such as a recommended item list, etc. Such information may be provided to the input/output unit of a terminal device through a network or internally.

The DB 203, which is recorded, updated, or read by the engine 101, stores various types of data which are intermediate data generated in the process of the engine 101, for example. The DB 203 is, for example, provided in a memory or storage device. As described below, in an embodiment of the present disclosure, for example, an item DB, cluster DB, recommended item DB, etc., may be provided as the DB 203 of the recommendation information generation unit 100. A plurality of the DBs 203 may all be concentrated and provided in a server or terminal device, or alternatively, may be distributed and provided in a server and terminal device, for example. For example, a server apparatus which has only the DB 203 may be provided, and in this case, the DB 203 is referenced by another server apparatus or terminal device which has the engine 101, through a network.

Note that, in each embodiment described below, whether each piece of data or information may be held as the above data/information 201 or the DB 203, may be arbitrarily set. Specifically, data or information described as the data/information 201 may be stored in the DB 203, or data or information described as the DB 203 may be held as the data/information 201.

### 3. Clustering of Scored Items

Next, first to fourth embodiments of the present disclosure relating to clustering of scored items will be described with reference to FIGS. 5-22.

FIG. 5 is a diagram showing the concept of clustering of items in an embodiment of the present disclosure. As shown in the diagram, in an embodiment of the present disclosure, items (Item1, Item2, Item3, . . . ) are grouped into clusters (ic1, ic2, ic3, . . . ). In the first to fourth embodiments described below, items which have been given a score for item recommendation using a certain technique are grouped into clusters according to the metadata (e.g., data such as a genre, release date, etc.) or scores themselves of the items.

Here, it should be noted that, instead of giving a score to items using the result of clustering, items which have already been given a score are grouped into clusters. As used herein, the score is for recommending an item to a user. Therefore, the score can be directly used to generate recommended item information. However, in the first to fourth embodiments of the present disclosure, items given a score are further grouped into clusters, and based on the result, recommended item information is generated, and therefore, item recommendation reflecting a wider variety of user preferences is achieved.

### 3-1. First Embodiment

FIG. 6 is a diagram schematically showing a process in a first embodiment of the present disclosure. In this embodiment, a scored item list 210 and item metadata 220 are provided as an input, and are processed by an item clustering engine 110, an extracting engine 120, and a recommendation engine 130, and recommended item information 270 for a user is output. In the course of the process, an item DB 230, a cluster DB 240, a number-of-recommended-items DB 250, and a recommended item DB 260 are generated.

FIG. 7 shows an example of the scored item list 210. The scored item list 210 has, for example, the fields of item IDs 211 and scores 213 corresponding to the respective item IDs 211. The items ID 211 are IDs for identifying the respective items. The scores 213 are calculated by, for example, content-based filtering, collaborative filtering, or other techniques. The scores 213 can be calculated using various known techniques, which will not be described in detail herein.

The scored item list 210 may be generated in the recommendation information generation unit 100 according to an embodiment of the present disclosure, or may be generated outside the recommendation information generation unit 100. In other words, the recommendation information generation unit 100 may include the engine 101, the DB 201, etc., for calculate scores given to items, in addition to the components of FIG. 6, or may not include these, and may externally obtain the scored item list 210.

On the other hand, the item metadata 220 is information indicating the metadata of each item. The metadata may be various types of information related to an item, such as, for example, an item type (a book, music content, video content, etc.), an item attribute (a genre, author, cast, etc.), a related keyword, etc. Although not shown, the item metadata 220 may also have the same field of the item ID 211 as that which is included in the scored item list 210, and metadata may be associated with each item.

The item metadata 220 may, for example, be obtained from a DB which is provided outside the recommendation information generation unit 100 according to an embodiment of the present disclosure. In this case, not all item metadata is necessarily possessed by a single DB. The item metadata 220 of different items may be obtained from different DBs. Alternatively, when the item metadata 220 is used to calculate the score 213 in the scored item list 210, the item metadata 220 may also be provided from a supply source of the scored item list 210.

The item clustering engine 110 performs clustering on items contained in the scored item list 210 according to the item metadata 220. The clustering using the metadata can be performed using various known techniques, such as, for example, k-means clustering, etc., and therefore, will not be described in detail herein. The item clustering engine 110 records the result of the clustering to the item DB 230 and the cluster DB 240.

FIG. 8 shows an example of the item DB 230. The item DB 230 has, for example, the fields of item IDs 211, scores 213, and cluster IDs 231. For the item IDs 211 and the scores 213, information contained in the scored item list 210 may be used. The cluster IDs 231 are IDs for identifying clusters (the clusters ic1-ic3 in the example of FIG. 5) into which items have been grouped as a result of clustering by the item clustering engine 110.

In the example shown, 12 items having an item ID 211 of “0007” to “0084” are given one of the cluster IDs 231 which are “1” to “3.” This indicates that six items having a cluster ID 231 of “1” have been grouped into a cluster c11, two items having a cluster ID 231 of “2” have been grouped into a cluster c12, and four items having a cluster ID 231 of “3” have been grouped into a cluster c13.

FIG. 9 shows an example of the cluster DB 240. The cluster DB 240 has, for example, the fields of cluster IDs 231 and number-of-items values 241. The cluster IDs 231, which are the same field as that which is included in the item DB 230, are IDs for identifying clusters into which items have been grouped. The number-of-items values 241 are the numbers of items which have been grouped into the respective clusters. For example, in the above example of FIG. 8, if, in all, there are only 12 items grouped into the clusters c11-c13, that are shown, the number of items in the cluster c11 (cluster ID: “1”) is six, the number of items in the cluster c12 (cluster ID: “2”) is two, and the number of items in the cluster c13 (cluster ID: “3”) is four.

Referring back to FIG. 6, next, the extracting engine 120 determines the number of recommended items which are to be extracted from each cluster, by referencing the cluster DB 240, and records this number to the number-of-recommended-items DB 250. Also, the extracting engine 120 extracts items the number of which is the number of recommended items, from each cluster by referencing the item DB 230, and records these items to the recommended item DB 260.

FIG. 10 shows an example of the number-of-recommended-items DB 250. The number-of-recommended-items DB 250 has, for example, the fields of cluster IDs 231 and number-of-recommended-items values 251. The cluster IDs 231, which are the same field as that which is included in the item DB 230, are IDs for identifying clusters into which items have been grouped. The number-of-recommended-items values 251 are the numbers of items which have been extracted as a recommended item from the respective clusters.

As described below, the number-of-recommended-items values 251 may, for example, be set based on the numbers of items (sizes of clusters) which have been grouped into the respective clusters. For example, the number of recommended items may be calculated by multiplying the number-of-items value 241 in the above cluster DB 240 by a predetermined parameter E. In the example shown, the number-of-recommended-items value 251 is determined using the parameter E=0.5.

When a recommended item is extracted based on the number-of-recommended-items value 251 thus determined, there are the following two techniques, for example. As a first technique, items may be sorted according to score in each cluster before being obtained. More specifically, when the item ID 211 is obtained from the item DB 230, the cluster ID 231 is specified, and items are sorted according to the score 213, and then, the m highest items are obtained (m is the number of recommended items in the cluster).

Alternatively, as a second technique, items may be obtained from each cluster randomly in terms of score. More specifically, when the item ID 211 is obtained from the item DB 230, the cluster ID 231 is obtained, and m items are obtained randomly without being sorted according to the score 213 (m is the number of recommended items in the cluster).

FIG. 11 shows an example recommended item DB 260a containing recommended items extracted using the first technique. Although the recommended item DB 260a may not necessarily contain the field of the cluster ID 231 or score 213, these fields are shown in FIGS. 11 and 12 for the purpose of description. In the example shown, according to the number-of-recommended-items value 251 of the above example, there are three recommended items (rc11a) extracted from the cluster c11, one recommended item (rc12a) extracted from the cluster c12, and two recommended items (rc13a) extracted from the cluster c13. Here, the recommended items rc11a are items having the three highest scores 213 in the cluster c11, the recommended item rc12a is an item having the highest score 213 in the cluster c12, and the recommended items rc13a are items having the two highest scores 213 in the cluster c13.

FIG. 12 shows an example recommended item DB 260b containing recommended items extracted using the second technique. In the example shown, there are three recommended items (rc11b) extracted from the cluster c11, one recommended item (rc12b) extracted from the cluster c12, and two recommended items (rc13b) extracted from the cluster c13. Here, the recommended items rc11b are three items extracted randomly from the cluster c11, the recommended item rc12b is one item extracted randomly from the cluster c12, and the recommended items rc13b are two items extracted randomly from the cluster c13.

Referring back to FIG. 6, next, the recommendation engine 130 outputs the recommended item information 270 by referencing the recommended item DB 260. The recommendation engine 130 obtains, for example, item names, item images, etc., corresponding to the item IDs 211 recorded in the recommended item DB 260, and generates the recommended item information 270. In this case, the recommended item information 270 thus generated is output to the user through the input/output unit of the terminal device, for example. Alternatively, the recommendation engine 130 may output a sequence of the item IDs 211 recorded in the recommended item DB 260 directly as the recommended item information 270. In this case, the recommended item information 270 thus generated may be provided to another service or may be accumulated for subsequent outputting, for example.

FIG. 13 is a flowchart showing an example process in the first embodiment of the present disclosure. Initially, information of items and scores is obtained (step S101). This information is the information which has been described as the scored item list 210 in the above example. The recommendation information generation unit 100 may internally generate this information by calculating the scores of items using the engine 101, the DB 201, etc., or may externally obtain this information.

Next, the item clustering engine 110 performs clustering on the items according to the item metadata 220 (step S103). The item clustering engine 110 records the result of the clustering to the item DB 230 and the cluster DB 240.

Next, the extracting engine 120 obtains the parameter E for determining the number of recommended items (step S105). Based on this, the number of recommended items is calculated for each cluster (step S107). In the above example, the number of recommended items extracted from each cluster is determined based on the size of the cluster. In this case, for example, the parameter E is previously set which indicates the ratio of the number of recommended items to the number of items which have been grouped into each cluster. The number of recommended items may be calculated based on the parameter E and the size of each cluster recorded in the cluster DB 240.

Here, the parameter E may be a fixed value or may be a value varying depending on the cluster size. When the parameter E is variable, the parameter E may be set to be inversely proportional to the cluster size, for example. In this case, for example, when the difference in cluster size is large, the difference is reduced, whereby a fairly large number of recommended items can be extracted from a cluster having a small size.

Next, the extracting engine 120 extracts recommended items from the item DB 230 for each cluster (step S109). As described above, items may be sorted according to score, and items having the m highest scores may be extracted as recommended items (m is the number of recommended items in the cluster), or m items may be extracted randomly without being sorted. The extracting engine 120 records information, such as, for example, the item IDs, of the extracted recommended items to the recommended item DB 260.

Next, the recommendation engine 130 outputs the recommended item information 270 based on the information obtained from the recommended item DB 260 (step S111). The recommendation engine 130 may output information, such as the item IDs, etc., recorded in the recommended item DB 260 directly as the recommended item information 270, or may convert information, such as the item IDs, etc., into item names, item images, etc., before outputting the resultant information to the recommended item information 270. For example, when the item ID is converted into an item name, item image, etc., the recommendation engine 130 references a DB of item names and item images which is provided inside or outside the recommendation information generation unit 100.

### Summary of First Embodiment

In this embodiment, items given a score for recommendation are grouped into clusters, and items are recommended for each cluster. Items are recommended from every cluster. Therefore, a bias which is likely to occur in the result of recommendation when items having higher scores are simply recommended can be prevented. Also, in this embodiment, the number of recommended items extracted from each cluster is determined based on the size of the cluster. Therefore, a larger number of recommended items are extracted from a cluster having a larger number of items (items given a score for recommendation).

### 3-2. Second Embodiment

FIG. 14 is a diagram schematically showing a process in a second embodiment of the present disclosure. The process of this embodiment is different from the process of the first embodiment described with reference to FIG. 6 in that none of the cluster DB 240 and the number-of-recommended-items DB 250 is generated. This is because, in this embodiment, a predetermined number of items are extracted as recommended items for each cluster.

FIG. 15 is a flowchart showing an example process in the second embodiment of the present disclosure. The process of this embodiment is different from the process of the first embodiment described with reference to FIG. 13 in that, after the item clustering engine 110 performs clustering on items according to the item metadata 220 (step S103), the extracting engine 120 extracts n number of recommended items (n is a predetermined number) from the item DB 230 for each cluster (step S209). Here, items may be sorted in order of score, and recommended items having the n number of highest scores may be extracted, or n number of recommended items may be extracted randomly without being sorted. The extracting engine 120 records information, such as, for example, item IDs, of the extracted recommended items to the recommended item DB 260.

Next, the recommendation engine 130 outputs the recommended item information 270 based on the information obtained from the recommended item DB 260 (step S111). Here, the process is similar to that of the above first embodiment.

Here, the number n which is previously set as the number of recommended items for each cluster may, for example, be one or two or more. Thus, the number of recommended items is set irrespective of the cluster size, and therefore, for example, the process of determining the number of recommended items can be removed, so that the process is simplified. Also, when different clusters have significantly different sizes, it is possible to prevent a situation that there is a large difference in the number of recommended items between clusters, and recommended items from a smaller cluster are less noticeable.

### 3-3. Third Embodiment

FIG. 16 is a diagram schematically showing a process in a third embodiment of the present disclosure. The process of this embodiment is different from the process of first embodiment described with reference to FIG. 6 in that the item metadata 220 is not supplied as an input. This is because, in this embodiment, an item clustering engine 310 performs clustering according to the item score. As a result, an item DB 320 and a recommended item DB 330 which have contents different from those of the first embodiment are generated. Note that clustering using scores can be performed using various known techniques as with clustering using metadata in the first embodiment, and therefore, will not be described in detail herein.

FIG. 17 shows an example of the item DB 320. The item DB 320 has, for example, the fields of item IDs 211, scores 213, and cluster IDs 321. As the item IDs 211 and the scores 213, information contained in the scored item list 210 may be used. The cluster IDs 321 are IDs for identifying clusters (the clusters ic1-ic3 in the example of FIG. 5) into which items have been grouped as a result of clustering by the item clustering engine 310.

In the example shown, 12 items having an item ID 211 of “0007”-“0084” are given any of the cluster IDs 321 which are “1”-“3.” This indicates that six items having a cluster ID 321 of “1” have been grouped into a cluster c21, two items having a cluster ID 321 of “2” have been grouped into a cluster c22, and four items having a cluster ID 321 of “3” have been grouped into a cluster c23.

Here, in this embodiment, clustering is performed according to the item score. Therefore, in the example shown, items grouped into the clusters c21-c23 can be inferred from the values of the scores 213. For example, items having a score of 0.88-0.98 have been grouped into the cluster c21. Also, items having a score of 0.49-0.55 have been grouped into the cluster c22. Items having a score of 0.21-0.24 have been grouped into the cluster c23. In this particular case where there are only three clusters, items having high scores have been grouped into the cluster c21, items having intermediate scores have been grouped into the cluster c22, and items having low scores have been grouped into the cluster c23.

When recommended items are extracted according to the number-of-recommended-items value 251 determined in a manner similar to that of the first embodiment, there are the following two techniques, for example. As a first technique, items may be sorted according to score for each cluster before recommended items are obtained. More specifically, when the item ID 211 is obtained from the item DB 230, the cluster ID 321 is specified, items are sorted according to the score 213, and items having the m highest scores (m is the number of recommended items in the cluster) are obtained.

Alternatively, as a second technique, items may be obtained randomly in terms of score for each cluster. More specifically, when the item ID 211 is obtained from the item DB 230, the cluster ID 321 is obtained, and m items are obtained randomly without being sorted according to the score 213 (m is the number of recommended items in the cluster).

FIG. 18 shows an example recommended item DB 330a which contains recommended items extracted by the first technique. Although the recommended item DB 330a may not necessarily contain the field of the cluster ID 321 or score 213, these items are shown in FIGS. 18 and 19 for the purpose of description. In the example shown, according to a number-of-recommended-items value 251 similar to the example of the first embodiment, there are three recommended items (rc21a) extracted from the cluster c21, one recommended item (rc22a) from the cluster c22, and two recommended items (rc23a) from the cluster c23. Here, the recommended items rc21a are items having the three highest scores 213 in the cluster c21, the recommended item rc22a is an item having the highest score 213 in the cluster c22, and the recommended items rc23a are items having the two highest scores 213 in the cluster c23.

FIG. 19 shows an example recommended item DB 330b containing recommended items extracted by the second technique. In the example shown, there are three recommended items (rc21b) extracted from the cluster c21, one recommended item (rc22b) extracted from the cluster c22, and two recommended items (rc23b) extracted from the cluster c23. Here, the recommended items rc21b are three items extracted randomly from the cluster c21, the recommended item rc22b is one item extracted randomly from the cluster c22, and the recommended items rc23b are two items extracted randomly from the cluster c23.

FIG. 20 is a flowchart showing an example process in the third embodiment of the present disclosure. The process of this embodiment is different from the process of the first embodiment described with reference to FIG. 13 in that the item clustering engine 310 performs clustering according to the item score (step S303). The other steps S101 and S105-S111 are processes similar to those of the first embodiment, and therefore, will not be described in detail.

### Summary of Third Embodiment

In this embodiment, when clustering is performed on items given a score for recommendation, the scores themselves given to the items are used. Items are grouped into different clusters according to the value of the score. Therefore, a bias which is likely to occur in the result of recommendation when items having higher scores are simply recommended can be prevented more directly. Which of the technique of using metadata in clustering as in the first embodiment, and the technique of using a score in clustering as in this embodiment, has a result more preferable for the user, depends on the situation. Therefore, one of these techniques may be suitably selected, depending on the situation.

### 3-4. Fourth Embodiment

FIG. 21 is a diagram schematically showing a process in a fourth embodiment of the present disclosure. The process of this embodiment is different from the process of the third embodiment with reference to FIG. 16 in that none of the cluster DB 240 and the number-of-recommended-items DB 250 is generated. This is because, in this embodiment, a predetermined number of items are extracted as recommended items for each cluster.

FIG. 22 is a flowchart showing an example process in the fourth embodiment of the present disclosure. The process of this embodiment is different from the process of the first embodiment described with reference to FIG. 20 in that, after the item clustering engine 310 performs clustering on items according to the item score (step S303), the extracting engine 120 extracts n number of recommended items (n is a predetermined number) from the item DB 320 for each cluster (step S209). Here, items may be sorted according to score, and items having the n number of highest scores may be extracted as recommended items, or n number of items may be extracted randomly without being sorted. The extracting engine 120 records information, such as, for example, item IDs, of the extracted recommended items to the recommended item DB 330.

Next, the recommendation engine 130 outputs the recommended item information 270 based on the information obtained from the recommended item DB 330 (step S111). Here, the process is similar to that of the above first embodiment.

Thus, the fourth embodiment is a combination of the above second embodiment and third embodiment. Therefore, according to this embodiment, a bias which is likely to occur in the result of recommendation when items having higher scores are simply recommended can be prevented more directly, and the process of determining the number of recommended items can be removed, so that the process is simplified. Also, it is possible to prevent a situation that when different clusters have significantly different sizes, recommended items from a smaller cluster are less noticeable.

### 4. Control of Number of Recommendation Lists

Next, a fifth embodiment of the present disclosure relating to the control of the number of recommendation lists will be described with reference to FIGS. 23-29.

FIG. 23 is a diagram showing the concept of the control of the number of recommendation lists in an embodiment of the present disclosure. Thus, in this embodiment, the number of recommended item lists 510 provided as recommended item information is controlled according to the type of users so that the number of recommended item lists 510 is one for users of Type A, two for users of Type B, and three for users of Type C, for example. As used herein, the user type is based on how many items a user has used for each cluster.

FIG. 24 is a diagram showing example user type classification according to the number of items which have been used for each cluster. For example, it is assumed that a user has used the above items (Item1, Item2, Item3, . . . ) shown in FIG. 5 as described below (although “User_purchase” is assumed, the use form of items is not limited to purchase).

User_purchase[1]={Item4, Item3, Item5, Item8, . . . }

In this case, Item4, Item3, and Item5 belong to the cluster ic2, and Item8 belongs to the cluster ic3. Therefore, the use of the above items may be described as information indicating the type of the user as follows.

Purchase_type[1]={3, 1, 0, 0, . . . }

This indicates that the number of items used which belong to a cluster (ic2) which contains the largest number of items used is three, the number of items used which belong to a cluster (ic3) which contains the second largest number of items used is one, and the number of items used which belong to the remaining clusters (ic1, ic4, . . . ) is zero.

FIG. 24 shows a histogram of the above Purchase_type, where the horizontal axis represents clusters c, and the vertical axis (frequency) represents the number of items used in each cluster. If the histogram is approximated using, for example, a Poisson distribution, the user type related to the use of items is indicated by the variance V[c]=L.

For example, a distribution dl is a distribution having a relatively large L. The user type indicated by such a distribution may be considered to be of the all-round type, the user of which uses items of various clusters in a well-balanced manner. On the other hand, a distribution d2 is a distribution having a relatively small L. The user type indicated by such a distribution may be considered to be of the limited type, the user of which uses items of limited clusters in a concentrated manner. Although the distributions d1 and d2 are shown as a representative example, the number of user types is not limited to the above two, and user types may be set while being divided into more stages.

### 4-1. Fifth Embodiment

FIG. 25 is a diagram schematically showing a process in the fifth embodiment of the present disclosure. In this embodiment, item metadata 220, a recommended item list 510, and a purchase log 520 are supplied as inputs. An item clustering engine 110, a user classifying engine 530, and a recommendation engine 560 process these inputs to output recommended item information 570 to the user. In the course of the process, an item DB 230, a purchase-cluster DB 540, and a user type DB 550 are generated.

The item metadata 220 is information indicating the metadata of each item as with that described in the above first embodiment. The item clustering engine 110 performs clustering according to the item metadata 220. Here, items to be grouped into clusters are not limited by, for example, the scored item list 210 in the first embodiment, and therefore, the item clustering engine 110 performs clustering on all items for which the item metadata 220 has been obtained, using the metadata. The item clustering engine 110 records the result of the clustering to the item DB 230.

Next, the user classifying engine 530 sorts items purchased by users according to cluster by referencing the purchase log 520 and the item DB 230, and records the result to the purchase-cluster DB 540. Moreover, the user classifying engine 530 classifies users according to the data of the purchase-cluster DB 540, and records the result of the classification to the user type DB 550.

FIG. 26 shows an example of the purchase log 520. The purchase log 520 has, for example, the fields of user IDs 521 and item IDs 211. The item ID 211 is the same field as that which is included in the item DB 230. The combination of the user ID 521 and the item ID 211 indicates that the user has purchased the item. The user classifying engine 530 identifies clusters to which items purchased by the user belong by, for example, referencing the item DB 230 using the item IDs 211 recorded in the purchase log 520.

FIG. 27 shows an example of the purchase-cluster DB 540. The purchase-cluster DB 540 has, for example, the fields of user IDs 521, cluster IDs 231, and amounts 541. The user ID 521 is the same field as that which is included in the purchase log 520. The cluster ID 231 is the same field as that which is included in the item DB 230. The amount 541 indicates the number of items belonging to each cluster, that have been purchased by the user. For example, in the example shown, the user having a user ID of “0001” has purchased three items belonging to the cluster having a cluster ID of “1” (e.g., the three purchased items may all be different or the same).

Here, for example, the user classifying engine 530 sorts the data of the purchase-cluster DB 540 in decreasing order of the amount 541 for each user ID 521 to create a histogram where the horizontal axis represents the cluster IDs 231, and the vertical axis (frequency) represents the amounts 541. This histogram has the same meaning as that of the histogram of FIG. 24 where the horizontal axis represents clusters, and the vertical axis (frequency) represents the number of items in each cluster. Therefore, for example, by approximating this histogram using a Poisson distribution, etc., and calculating the variance value, the user type can be quantitatively classified.

FIG. 28 shows an example of the user type DB 550. The user type DB 550 has, for example, the fields of user IDs 521 and types 551. The user ID 521 is the same field as that which is included in the purchase log 520. The type 551 indicates a user type which has been determined based on the data of the purchase-cluster DB 540. Although, in the example shown, only two types, the limited type and the all-round type, are shown, there may be more types.

Referring back to FIG. 25, next, the recommendation engine 560 extracts a predetermined number of lists from the recommended item list 510 by referencing the purchase-cluster DB 540 and the user type DB 550, and outputs the lists as the recommended item information 570. For example, the recommendation engine 560 provides a larger number of lists as the recommended item information 570 to a user who tends to use a wider range of items, i.e., a user of the above all-round type, and a smaller number of lists as the recommended item information 570 to a user who tends to use a more limited range of items, i.e., a user of the above limited type. The purchase-cluster DB 540 is used when the recommended item list 510 is selected, as described below.

Here, the recommended item list 510 is output as several lists containing items recommended to a user. The recommended item list 510 may not necessarily correspond to clusters set by the item clustering engine 110. Specifically, items belonging to the same cluster may be contained in different recommended item lists 510, or items belonging to different clusters may be contained in the same recommended item list 510.

Also, for example, as the recommended item list 510, the recommended item information 270 output in the above first to fourth embodiments may be used. In this case, it may be assumed that recommended items extracted from different clusters are contained in different recommended item lists 510. Also in this case, the item clustering in the first to fourth embodiments may not necessarily be performed according to the item metadata, and the clustering is performed on only items given a score instead of all items, and therefore, the recommended item list 510 does not necessarily correspond to clusters set by the item clustering engine 110.

FIG. 29 is a flowchart showing an example process in the fifth embodiment of the present disclosure. Initially, the item clustering engine 110 performs clustering according to the item metadata (step S501). If clustering is performed on all items for which metadata has been set, the process load is large. Therefore, this process may, for example, be previously performed when the metadata of an item is set or updated. The result of the clustering is recorded to the item DB 230.

Next, the user classifying engine 530 totals the purchase log 520 of users for each cluster set in the item DB 230 to generate the purchase-cluster DB 540 (step S503). The user classifying engine 530 classifies users according to a purchase distribution of each cluster indicated by the purchase-cluster DB 540 (step S505). The classification is performed by setting one or more thresholds for the variance of the distribution (e.g., the variance V[c]=L in the example of FIG. 24), for example. The result of the classification is recorded to the user type DB 550.

Next, the recommendation engine 560 determines whether or not the recommended item lists 510 need to be narrowed for each user (step S507). Here, the recommended item lists 510 need to be narrowed when the number of the recommended item lists 510 is larger than the number of recommended item lists which are set, depending on the user type of a user, and are suitably recommended to the user.

For example, when there are a large number of the recommended item lists 510, then if the user type is the above limited type, any (one or more) of the recommended item lists 510 may be selected and recommended. Also, even when the user type is the above all-round type, then if the number of the recommended item lists 510 is considerably large, the recommended item lists are narrowed.

If, in step S507, it is determined that the recommended item lists 510 need to be narrowed, the recommendation engine 560 calculates an average vector of a cluster which contains recommended items which have been frequently purchased by the user (step S509). As used herein, the average vector is the average (centroid) of feature vectors which are a type of metadata of items belonging to the cluster, for example.

Next, the recommendation engine 560 selects k number of recommended item lists 510 which are closest to the average vector calculated in step S509 (step S511). For example, the recommendation engine 560 calculates the average (centroid) of the feature vectors of items contained in each recommended item list 510, and selects recommended item lists 510 whose average feature vector is closer to the above average vector. Note that k is the number of recommended item lists 510 which should be selected, is the number being set for each user type.

On the other hand, when, in step S507, it is determined that the recommended item lists 510 do not need to be narrowed, the recommendation engine 560 selects all of the recommended item lists 510 (step S513).

Next, the recommendation engine 560 outputs information of recommended items extracted from the recommended item lists 510 selected by the process of any of step S509, S511 or step S513, as the recommended item information 570 (step S515).

### Summary of Fifth Embodiment

In this embodiment, when recommended items are provided as a plurality of lists, the number of lists which should be presented as recommended items to a user is controlled based on the type of the user. The user type may be determined based on the variance in the number of items used by the user between each cluster. When recommended item lists are narrowed before being presented to a user, a recommended item list which is closer to clusters in which a larger number of items are used by the user may be selected. As a result, more suitable item recommendation can be performed, depending on the type of a user and a pattern of items used by the user.

### 5. Classification of Items Using User Clustering

Next, a sixth and a seventh embodiment relating to classification of item characteristics based on the result of clustering of users will be described with reference to FIGS. 30-38.

FIG. 30 is a diagram showing the concept of clustering of users in an embodiment of the present disclosure. As shown in FIG. 30, in the embodiment of the present disclosure, users (User1, User2, User3, . . . ) are grouped into clusters (uc1, uc2, uc3, . . . ). In the following sixth and seventh embodiments, users are grouped into clusters using a certain technique. For example, users may be grouped into clusters according to an attribute of the users themselves, such as age, gender, etc. Also, as in the above fifth embodiment, users may be grouped into clusters according to a pattern of items used (i.e., this embodiment may be combined with the fifth embodiment).

In the embodiments described below, items are classified according to the result of the above clustering of users. For example, it is assumed that a certain item has been used by users (User1, User2, User3, . . . ) shown in FIG. 30 as follows (although “Item purchase” is described, the use form of items is not limited to purchase).

Item_purchase[1]={User4, User3, User5, User 8, . . . }

In this case, User4, User3, and User5 belong to the cluster uc2, and User8 belongs to the cluster uc3. Therefore, the above use of the item can be described as information indicating the type of the item as follows.

Purchase_type[1]={3, 1, 0, 0, . . . }

This indicates that the number of users (utilization users) who have used items and who belong to the cluster (uc2) which includes the largest number of utilization users is three, the number of utilization users who belong to the cluster (uc3) which includes the second largest number of the utilization users is one, and the number of utilization users who belong to the remaining clusters (ic1, ic4, . . . ) is zero.

If a histogram of the above Purchase type is created where the horizontal axis represents clusters c, and the vertical axis (frequency) represents the number of utilization users for each cluster, a distribution is obtained which is similar to that which has been described in the fifth embodiment with reference to FIG. 24. If this histogram is approximated using, for example, a Poisson distribution, the type of the item related to utilization users is indicated by the variance V[c]=L.

A description will now be given with reference back to FIG. 24. For example, the distribution d1 is a distribution having a relatively large L. The item type indicated by such a distribution may be considered as a popular item which is widely used by users in various clusters. On the other hand, the distribution d2 is a distribution having a relatively small L. The item type indicated by such a distribution may be considered as an advanced item which is used by users in limited clusters in a concentrated manner. Although the distributions d1 and d2 are shown as a representative example, the number of user types is not limited to the above two, and user types may be set while being divided into more stages.

### 5-1. Sixth Embodiment

FIG. 31 is a diagram showing the concept of extraction of a recommended item sublist in a sixth embodiment of the present disclosure. In this embodiment, different recommended items sublists 511a and 511b containing different types of recommended items are extracted from the recommended item list 510. A recommended item sublist 511 may be extracted, corresponding to a type of items, such as, for example, the above popular items, advanced items, etc.

FIG. 32 is a diagram schematically showing a process in the sixth embodiment of the present disclosure. In this embodiment, user information 610, a recommended item list 510, and a purchase log 520 are supplied as inputs. Note that the recommended item list 510 and the purchase log 520 are information similar to those of the above fifth embodiment. A user clustering engine 620, an item classifying engine 640, and a recommendation engine 670 process these inputs to output a recommended item sublist 511. In the course of the process, a user DB 630, a purchase-cluster DB 650, and an item type DB 660 are generated.

The user information 610 may be any information that can be used for clustering users using the user clustering engine 620. For example, the user information 610 may be metadata which indicates an attribute, etc., of each user. Also, the user information 610 may be a result of classification of users according to the pattern of use of items in the above fifth embodiment.

The user clustering engine 620 performs clustering according to the user information 610. The clustering using the metadata can be performed using various known techniques, such as, for example, k-means clustering, etc., and therefore, will not be described in detail herein. The user clustering engine 620 records the result of the clustering to the user DB 630.

FIG. 33 shows an example of the user DB 630. The user DB 630 has, for example, the fields of user IDs 631 and user cluster IDs 633. The user cluster IDs 633 are IDs for identifying clusters (the clusters uc1-uc3 in the example of FIG. 30) into which users have been grouped as a result of clustering by the user clustering engine 620.

Referring back to FIG. 32, next, the item classifying engine 640 sorts users which have purchased items according to cluster by referencing the purchase log 520 and the user DB 630, and records the result to the purchase-cluster DB 650. Moreover, the item classifying engine 640 classifies items according to the data of the purchase-cluster DB 650, and records the result of the classification to the item type DB 660.

FIG. 34 shows an example of the purchase-cluster DB 650. The purchase-cluster DB 650 has, for example, the fields of item IDs 211, user cluster IDs 633, and amounts 651. The item ID 211 is the same field as that which is included in the purchase log 520, and the user cluster ID 633 is the same field as that which is included in the user DB 630. The amount 651 indicates the number of items purchased by users which have been grouped into clusters. For example, in the example shown, the item having an item ID of “0001” has been purchased three times by a user(s) which belongs to the cluster having a user cluster ID of “1” (e.g., three users may have purchased the item, or one user may have purchased the item in an amount of three).

Here, for example, the item classifying engine 640 sorts the data of the purchase-cluster DB 650 in decreasing order of the amount 651 for each item ID 211, and creates a histogram where the horizontal axis represents the user cluster IDs 633, and the vertical axis (frequency) represents the amounts 651. As described above, for example, by approximating this histogram using a Poisson distribution, etc., and calculating the variance value, the item type can be quantitatively classified.

FIG. 35 shows an example of the item type DB 660. The item type DB 660 has, for example, the fields of item IDs 211 and types 661. The item ID 211 is the same field as that which is included in the purchase log 520 and the recommended item list 510. The type 661 indicates the type of an item which has been determined based on the data of the purchase-cluster DB 650. Although, in the example shown, only two types, i.e., the advanced type and the popular type, have been described, there may be more types.

Referring back to FIG. 32, next, the recommendation engine 670 extracts a recommended item sublist 511 from the recommended item list 510 by referencing the item type DB 660. For example, the recommendation engine 670 extracts a recommended item sublist 511 for each item type, such as the popular item and advanced item in the above example. The recommended item sublists 511 thus extracted may be selected, depending on the history of use of items by users, etc. For example, a recommended item sublist 511 for popular items may be presented to all users. On the other hand, a recommended item sublist 511 for advanced items may be presented to only users that have already purchased other similar items (e.g., other items grouped into the same cluster in clustering performed according to the metadata).

Note that, as in the above fifth embodiment, the recommended item list 510 may, for example, be the recommended item information 270 which is output in the above first to fourth embodiments. In this case, recommended items extracted from different clusters may be assumed to be included in different recommended item lists 510.

FIG. 36 is a flowchart showing an example process in the sixth embodiment of the present disclosure. Initially, the user clustering engine 620 performs clustering on users according to the user information 610 (step S601). If clustering is performed on all users which are defined in the user information 610, the process load is large. Therefore, this process may, for example, be previously performed when the user information 610 is set or updated. The result of the clustering is recorded to the user DB 630.

Next, the item classifying engine 640 totals the purchase log 520 of items for each user cluster set in the user DB 630 to generate the purchase-cluster DB 650 (step S603). The item classifying engine 640 also classifies items according to a purchase distribution of each user cluster indicated by the purchase-cluster DB 650 (step S605). The classification is performed by setting one or more thresholds for the variance of the distribution (e.g., the variance V[c]=L in the example of FIG. 24), for example. The result of the classification is recorded to the item type DB 660.

Next, the recommendation engine 670 extracts a recommended item sublist 511 from the recommended item list 510 based on the classification of items recorded in the item type DB 660 (step S607), and outputs the extracted recommended item sublist 511 (step S609).

### Summary of Sixth Embodiment

In this embodiment, items are classified according to the distribution of users which use the items, and based on this classification, a sublist is extracted from a recommended item list. As a result, in a recommended item list, items suitable for different users to which the items are to be recommended can be separated into, for example, popular items and advanced items.

### 5-2. Seventh Embodiment

FIG. 37 is a diagram schematically showing a process in the seventh embodiment of the present disclosure. The process of this embodiment is different from the process of the sixth embodiment described with reference to FIG. 32 in that a recommended item DB 710 is referenced instead of providing the recommended item list 510. Therefore, the recommendation engine 670 generates a recommended item sublist 511 based on data of the recommended item DB 710 instead of extracting a recommended item sublist 511 from the recommended item list 510.

For example, as the recommended item DB 710, the recommended item DB 260 and recommended item 330 which are generated in the above first to fourth embodiments may be used. In other words, this embodiment may be carried out in combination with the above first to fourth embodiments. Of course, the recommended item DB 710 may be a DB in which information of recommended items extracted using any other techniques is recorded.

FIG. 38 is a flowchart showing an example process in the seventh embodiment of the present disclosure. The process of this embodiment is different from the process of the sixth embodiment described with reference to FIG. 36 in that items are classified by the item classifying engine 640 according to a purchase distribution of each user cluster (step S605), and thereafter, the recommendation engine 670 generates a recommended item sublist 511 based on information of recommended items recorded in the recommended item DB 710, according to the classification of items recorded in the item type DB 660.

### 6. Hardware Configuration

Next, a hardware configuration of the information processing apparatus according to an embodiment of the present disclosure will be described with reference to FIG. 39. FIG. 39 is a block diagram for explaining the hardware configuration of the information processing apparatus. An information processing apparatus 900 illustrated in the figure may realize the terminal device or the server apparatus in the aforementioned embodiments.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 temporarily stores program which are used in the execution of the CPU 901 and parameters which are appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 is a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as an LCD (Liquid Crystal Display), a PDP (Plasma Display Panel), and an organic EL (Electro-Luminescence) displays, an audio output device such as a speaker or a headphone, and a peripheral device such as a printer. The output device 917 may output the results obtained from the process of the information processing apparatus 900 in a form of a video such as text or an image, and an audio such as voice or sound.

The storage device 919 is a device for data storage which is configured as an example of a storage unit of the information processing apparatus 900. The storage device 919 includes, for example, a magnetic storage device such as a HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 writes in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

### 7. Supplement

An embodiment of the present disclosure may, for example, include information processing apparatuses (terminal devices or server apparatuses), systems, information processing methods performed in the information processing apparatuses or systems, that are described above, and programs for allowing the information processing apparatuses to function, and recording media storing the programs.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An information processing apparatus including:

an item clustering unit which groups scored items which are items given scores for recommendation to users, into a plurality of scored item clusters;

an extraction unit which extracts a predetermined number of items from each of the scored item clusters; and

an item recommendation unit which outputs item recommendation information which is used to recommend the extracted items to the users.

(2)

The information processing apparatus according to (1), wherein

the predetermined number is calculated based on the number of items which have been grouped into each of the scored item clusters.

(3)

The information processing apparatus according to (2), wherein

the predetermined number is calculated by multiplying the number of items which have been grouped into each of the scored item cluster by a parameter which is inversely proportional to the number of the items.

(4)

The information processing apparatus according to (1), wherein

the predetermined number is constant irrespective of the number of items which have been classified into each of the scored item clusters.

(5)

The information processing apparatus according to any one of (1) to (4), wherein

the item clustering unit groups the scored items into the plurality of scored item clusters according to metadata of each item.

(6)

The information processing apparatus according to any one of (1) to (4), wherein

the item clustering unit groups the scored items into the plurality of scored item clusters according to the scores.

(7)

The information processing apparatus according to any one of (1) to (6), wherein

the extraction unit extracts the predetermined number of items from each of the scored item clusters in decreasing order of the scores.

(8)

The information processing apparatus according to any one of (1) to (6), wherein

the extraction unit extracts the predetermined number of items randomly from each of the scored item clusters.

(9)

The information processing apparatus according to any one of (1) to (8), further including:

a score calculation unit which calculates the scores.

(10)

The information processing apparatus according to any one of (1) to (8), further including:

an information obtaining unit which externally obtains information of the scored items.

(11)

The information processing apparatus according to any one of (1) to (10), further including:

a communication unit which sends the item recommendation information to terminal devices of the users.

(12)

The information processing apparatus according to any one of (1) to (10), further including:

an output unit which presents the item recommendation information to the users.

(13)

The information processing apparatus according to any one of (1) to (12), further including:

a user classifying unit which determines classification of the users based on a distribution of items used by the users in item clusters into which the items have been grouped according to metadata of each item,

wherein the item recommendation unit generates a plurality of recommended item lists respectively corresponding to the plurality of scored item clusters, and selects and outputs all or a portion of the plurality of recommended item lists based on the classification of the users, as the item recommendation information.

(14)

The information processing apparatus according to (13), wherein

the item recommendation unit, when selecting a portion of the plurality of recommendation lists, selects a recommendation list similar to the item cluster which includes a larger number of items used by the users.

(15)

The information processing apparatus according to any one of (1) to (12), further including:

a user clustering unit which groups the users into user clusters; and

an item classifying unit which determines classification of the items based on a distribution of users who have used the items in the user clusters,

wherein the item recommendation unit creates a plurality of recommended item lists respectively corresponding to the plurality of scored item clusters, and extracts and outputs recommended item sublists respectively from the plurality of recommended item lists according to the classification of the items, as the item recommendation information.

(16)

The information processing apparatus according to any one of (1) to (12) further including:

a user clustering unit which groups the users into user clusters; and

an item classifying unit which determines classification of the items based on a distribution of the users who have used the items in the user clusters,

wherein the item recommendation unit generates a plurality of recommended item sublists from the extracted scored items according to the classification of the items, and outputs the plurality of recommended item sublists as the item recommendation information.

(17)

An information processing method including:

grouping scored items which are items given scores for recommendation to users, into a plurality of scored item clusters;

extracting a predetermined number of items from each of the scored item clusters; and

outputting item recommendation information which is used to recommend the extracted items to the users.

(18)

A system including:

a terminal device; and

one or more server apparatuses which provide a service to the terminal device,

wherein the terminal device and the one or more server apparatuses provide, in cooperation with each other, the functions of

grouping scored items which are items given scores for recommendation to users, into a plurality of scored item clusters,

extracting a predetermined number of items from each of the scored item clusters, and

outputting item recommendation information which is used to recommend the extracted items to the users.

### REFERENCE SIGNS LIST

10, 30, 50 terminal device

20, 40 server

11 input/output unit

21 information obtaining unit

22, 31, 41 recommendation information generation unit

100 recommendation information generation unit

110, 310 item clustering engine

120 extracting engine

130, 560, 670 recommendation engine

530 user classifying engine

620 user clustering engine

640 item classifying engine

1. An information processing apparatus comprising:
an item clustering unit which groups scored items which are items given scores for recommendation to users, into a plurality of scored item clusters;
an extraction unit which extracts a predetermined number of items from each of the scored item clusters; and
an item recommendation unit which outputs item recommendation information which is used to recommend the extracted items to the users.

2. The information processing apparatus according to claim 1, wherein
the predetermined number is calculated based on the number of items which have been grouped into each of the scored item clusters.

3. The information processing apparatus according to claim 2, wherein
the predetermined number is calculated by multiplying the number of items which have been grouped into each of the scored item cluster by a parameter which is inversely proportional to the number of the items.

4. The information processing apparatus according to claim 1, wherein
the predetermined number is constant irrespective of the number of items which have been classified into each of the scored item clusters.

5. The information processing apparatus according to claim 1, wherein
the item clustering unit groups the scored items into the plurality of scored item clusters according to metadata of each item.

6. The information processing apparatus according to claim 1, wherein
the item clustering unit groups the scored items into the plurality of scored item clusters according to the scores.

7. The information processing apparatus according to claim 1, wherein
the extraction unit extracts the predetermined number of items from each of the scored item clusters in decreasing order of the scores.

8. The information processing apparatus according to claim 1, wherein
the extraction unit extracts the predetermined number of items randomly from each of the scored item clusters.

9. The information processing apparatus according to claim 1, further comprising:
a score calculation unit which calculates the scores.

10. The information processing apparatus according to claim 1, further comprising:
an information obtaining unit which externally obtains information of the scored items.

11. The information processing apparatus according to claim 1, further comprising:
a communication unit which sends the item recommendation information to terminal devices of the users.

12. The information processing apparatus according to claim 1, further comprising:
an output unit which presents the item recommendation information to the users.

13. The information processing apparatus according to claim 1, further comprising:
a user classifying unit which determines classification of the users based on a distribution of items used by the users in item clusters into which the items have been grouped according to metadata of each item,
wherein the item recommendation unit generates a plurality of recommended item lists respectively corresponding to the plurality of scored item clusters, and selects and outputs all or a portion of the plurality of recommended item lists based on the classification of the users, as the item recommendation information.

14. The information processing apparatus according to claim 13, wherein
the item recommendation unit, when selecting a portion of the plurality of recommendation lists, selects a recommendation list similar to the item cluster which includes a larger number of items used by the users.

15. The information processing apparatus according to claim 1, further comprising:
a user clustering unit which groups the users into user clusters; and
an item classifying unit which determines classification of the items based on a distribution of users who have used the items in the user clusters,
wherein the item recommendation unit creates a plurality of recommended item lists respectively corresponding to the plurality of scored item clusters, and extracts and outputs recommended item sublists respectively from the plurality of recommended item lists according to the classification of the items, as the item recommendation information.

16. The information processing apparatus according to claim 1, further comprising:
a user clustering unit which groups the users into user clusters; and
an item classifying unit which determines classification of the items based on a distribution of the users who have used the items in the user clusters,
wherein the item recommendation unit generates a plurality of recommended item sublists from the extracted scored items according to the classification of the items, and outputs the plurality of recommended item sublists as the item recommendation information.

17. An information processing method comprising:
grouping scored items which are items given scores for recommendation to users, into a plurality of scored item clusters;
extracting a predetermined number of items from each of the scored item clusters; and
outputting item recommendation information which is used to recommend the extracted items to the users.

18. A system comprising:
a terminal device; and
one or more server apparatuses which provide a service to the terminal device,
wherein the terminal device and the one or more server apparatuses provide, in cooperation with each other, the functions of
grouping scored items which are items given scores for recommendation to users, into a plurality of scored item clusters,
extracting a predetermined number of items from each of the scored item clusters, and
outputting item recommendation information which is used to recommend the extracted items to the users.
